(19) United States
(12) Patent Application Publication
(10) Pub. No.: US 2011/0117462 A1
(43) Pub. Date: May 19, 2011

(54) Methods and apparatuses for distributed fuel cells with nanotechnology

(76) Inventor: Walter E. Pelton, San Jose, CA (US)

(21) Appl. No.: 13/006,031

(22) Filed: Jan. 13, 2011

Related U.S. Application Data
(63) Continuation-in-part of application No. 11/489,274, filed on Jul. 18, 2006, now Pat. No. 7,892,681.

(51) Int. Cl. H01M 8/04

(52) U.S. Cl. 429/428

(57) ABSTRACT

An electrochemical cell which includes an anode half-cell, a cathode half-cell, an ion-host species formed within the reactant path between the two half-cells, an optional gate electrode influencing the electrical potential of the ions, and an optional mechanical interchange influencing the rate of charge transfer. Mechanical energy may be interchanged with chemical energy. The half-cells may be operated independently by accumulation and deployment of the ion-host intermediate species.

### REFERENCE TO RELATED APPLICATIONS

This application is a continuation in part of:
U.S. Provisional Application No. 60/700,954 entitled “Methods and apparatuses for distributed fuel cells with transistor system” filed Jul. 19, 2005, and
U.S. patent application Ser. No. 13/006115 filed Jan. 13, 2011, entitled “Methods and apparatuses for distributed fuel cells with transistor system”, and
Application Ser. No. 11/489,274 Jul. 18, 2006, entitled “Methods and apparatuses for distributed fuel cells with microelectronic structures” now U.S. Pat. No. 7,892,681; and claims benefit of each and each are incorporated by reference in their entirety, except where inconsistent with the present application.

### BACKGROUND

The distribution of power to support large sets of circuit modules has been challenging because the required voltages and acceptable voltage variances both continue to decrease, while the required peak currents continue to increase. For example, a communications processor currently requires a power source that can provide high current at a low voltage, and a large number of capacitors of multiple values to smooth out high frequency edges and meet surges that fall into different ranges between the high frequency and the response capability of the power supply. Integrated circuit technology has been able to replace the functionality of many devices in digital logic and to produce many analog devices compatibly on a substrate. Power sources have been necessarily handled from outside the chip and this has required lossy and bulky structures to implement power paradigms that maintain low power supply regulated voltage with respect to a common ground. In addition, it is common to have multiple voltage requirements for a single central processor unit. Furthermore, the power is routed by many conductive traces, where even a slight resistance causes large differential voltage drops. No small, efficient power source has been able to be integrated on the chip with the logic. No power source has been able to be produced in the wafer processing cycle without individual manual operations being done to install special elements such as membrane materials. As a result, no simple biasing paradigms have been developed to permit the lower power and higher speeds that can be achieved.

An electrochemical cell is an example of a bias source that may have millimeter or nanometer dimensions. An electrochemical cell includes two half-cells, each of which includes an electrode and a reagent. The reagent in one half-cell undergoes an oxidation reaction at the anode, producing electrons as one reaction product. The reagent in the other half-cell undergoes a reduction reaction at the cathode, consuming electrons as a reactant. Ionic balance between the two half-cells is maintained by an ion-conducting interface between the half-cells. The electron flow from the anode to the cathode will provide an electrical current to an electrical load connected to the two electrodes.

In order for complementary half-cell reactions to take place in an electrochemical cell, ions must travel between the two electrodes. In a conventional electrochemical cell, an ion conducting interface is present between the electrodes. The interface prevents bulk mixing of the reductant and oxidant, but permits ions to flow between the two electrodes. Examples of ion conducting interfaces include a salt bridge, a polymer electrolyte membrane, and an induced dynamic conducting interface (IDCI). Electrochemical cells that include an IDCI are described, for example, in U.S. Pat. No. 6,713,206 B2.

The reagent in the half-cell containing the cathode is an oxidant, since it undergoes a reduction reaction at the cathode. The reagent in the half-cell containing the anode is a reductant, since it undergoes an oxidation reaction at the anode. The electrons produced at the anode can travel through an external circuit to the cathode, where electrons react with the oxidant at the cathode catalyst to produce a reduced product. When the electrochemical cell is a fuel cell, the reductant is a fuel.

Hydrogen, methanol and formic acid have emerged as important fuels for fuel cells, particularly in mobile power and transportation applications. The electrochemical half reactions for a hydrogen fuel cell are listed below.

| | | |
|---|---|---|
| Anode: | 2H₂ → | 4 H⁺ + 4 e⁻ |
| Cathode: | O₂ + 4 H⁺ + 4 e⁻ → | 2 H₂O. |
| Cell Reaction: | 2 H₂ + O₂ → | 2 H₂O |

To avoid storage and transportation of hydrogen gas, the hydrogen can be produced by reformation of conventional hydrocarbon fuels. In contrast, direct liquid fuel cells (DLFCs) utilize liquid fuel directly, and do not require a preliminary reformation step of the fuel. As an example, the electrochemical half reactions for a Direct Methanol Fuel Cell (DMFC) in acidic conditions are listed below.

| | | |
|---|---|---|
| Anode: | CH₃OH + H₂O → | CO₂ + 6 H⁺ + 6 e⁻ |
| Cathode: | 1.5 O₂ + 6 H⁺ + 6 e⁻ → | 3 H₂O. |
| Cell Reaction: | CH₃OH + 1.5 O₂ → | CO₂ + 2 H₂O |

As another example of a DLFC, the electrochemical half reactions for a Formic Acid Fuel Cell (FAFC) in acidic conditions are listed below.

| | | |
|---|---|---|
| Anode: | HC(═O)OH → | CO₂ + 2 H⁺ + 2 e⁻ |
| Cathode: | O₂ + 2 H⁺ + 2 e⁻ → | 2 H₂O. |
| Cell Reaction: | HC(═O)OH + O₂ → | CO₂ + 2 H₂O |

Several types of fuel cells have been constructed, including polymer electrolyte membrane fuel cells, direct methanol fuel cells, alkaline fuel cells, phosphoric acid fuel cells, molten carbonate fuel cells, and solid oxide fuel cells. For a comparison of several fuel cell technologies, see Los Alamos National Laboratory monograph LA-UR-99-3231 entitled Fuel Cells: Green Power by Sharon Thomas and Marcia Zalbowitz.

### SUMMARY

In one aspect, the invention is an electronic device, comprising an integrated circuit comprising a plurality of domains (see definition below), and at least one bias source. Each domain of the plurality of domains is independently electrically connected to at least one of the at least one bias source.

In another aspect, the invention provides a method and process to integrate fuel cells with logic at the design level and fabricate them together in a wafer process in a foundry including support of reactant reconstitution and recirculation.

In another aspect, the invention provides a high specific energy fuel cell that can be fabricated in plastic and various materials and with efficient processes such as to be arrayed three-dimensionally.

In yet another aspect, the invention provides a gated fuel cell that can be quickly switched on or off or controlled to provide variable output power.

In yet another aspect, the invention provides a contamination-limited provision and replenishment of the reactants.

The following definitions are included to provide a clear and consistent understanding of the specification and claims.

The term “electronic device” is a device that includes an electrical circuit. Electronic devices include, for example, microprocessors, application-specific integrated circuits (ASICs), memory chips, analog integrated circuits, computers, mobile phones, airplanes or automobiles.

The term “integrated circuit” includes all the semiconductor devices on a single semiconductor substrate, configured to provide an electrical output or outputs in response to an electrical input or inputs.

The term “domain” is one or more independently electrically connected section of an electrical circuit. Domains include, for example, logic domains, arithmetic domains and memory domains.

The term “semiconductor device” includes a solid-state circuit element. Semiconductor devices include, for example, resistors, capacitors, p-n diodes, bipolar junction transistors, and field-effect transistors.

The term “bias source” is an element that increases or decreases the electrical potential applied to a system. Examples include fuel cells, batteries and power supplies.

The term “independently electrically connected” is a circuit portion that may be biased without changing the biasing state of any other circuit portions electrically connected to some bias source.

The term “cell” includes one or more of elements interconnected to provide a desired electrical property.

The term “membrane” encompasses a material between two half-cells forming part of the current path and which has properties that differ from those of the half-cell reactants. Such properties generally include being solid rather than liquid plus other properties that may be optimized in the construction of a cell. This term is usually limited to a continuous chemical substance.

The term “structured membrane” is a structural device that is typically not ion-conductive with inclusions of ion-conductive chemicals. The entire device may be made part of the path between two half-cells and will function as a membrane. The structural lattice extends the solid near the structural elements but with the extended material being ion-conductive. This ordered lattice may extend completely between members of the fine structure of solids and may thus behave as a true membrane. In other cases, the ordering may only include part of the intra-structural space and the membrane may be only a shield with holes which can limit flow between the half-cells but not withstand pressure. For the present purpose the term will include both cases and assume that any final design will accommodate the actual case. Examples include, slots cut into surfaces of silicon and then oxidized to a form a surface of silicon dioxide and filled with water with some concentration of acidic ions or a gel of sodium silicate filling a space and maintaining a structure of threads that produce an aqueous form with structural properties but permeable to mobile carriers, an ion-permeable substance in a form that is altered by the proximity of the sides of the slot. It should be understood by one of ordinary skill in the art that these examples are merely for illustrative purposes and that many other examples could be used.

The term “membrane gate” is a liquid or solid portion of the conduction path between two half-cells having ionic conductivity that may be changed by application of an electric field.

The term “porous matrix” may include an amorphous type of the structured membrane which differs by having been formed in a pseudo-random process as opposed to photo-mask and etch procedures. Examples include porous silicon, sand and silicon carbide bounded by silicon dioxide or silicon nitride surfaces and including water molecules.

The term “electrode” is intended to mean the combination of the conductive contact and the anode catalyst (as required) or the conductive contact and the cathode catalyst (as required), respectively.

The term “semiconductor device” is intended to mean any type of semiconductor device that includes, but is not limited to logic devices, digital devices, sensor devices, temperature devices, or the like.

The term “via” refers to an opening from one position in space to another position in space on a substrate and is used as a noun with the plural being “vias”.

The term “gated electrochemical cell” refers to a chemical fuel cell wherein ions can be influenced by a voltage or a bias from a gate electrode.

### BRIEF DESCRIPTION OF THE DRAWINGS

The invention may be better understood with reference to the following drawings and descriptions. The components in the figures are not necessarily to scale, emphasis instead being placed upon illustrating the principles of the invention.

FIG. 1 is a simplified schematic illustration of an electronic device.

FIG. 2 is a simplified enlarged illustration of a gated electrochemical cell.

FIG. 3 is a simplified enlarged illustration of a gated electrochemical cell having a membrane gate that includes a structured field effect material.

FIG. 4 is a simplified enlarged illustration of a gated electrochemical cell having a membrane gate that includes a porous field effect material.

FIG. 5 is an enlarged perspective illustration of a partially constructed gated electrochemical cell.

FIG. 6 is an enlarged perspective illustration of a partially constructed electrochemical cell system.

FIG. 7A through FIG. 7F are enlarged illustrations of simplified structures formed during an example of a method of making a gated electrochemical cell having a membrane gate that includes a structured field effect material.

FIG. 8A through FIG. 8F are simplified enlarged illustrations of structures formed during an example of a method of making a gated electrochemical cell having a membrane gate that includes a porous field effect material.

FIG. 9 is an enlarged illustration of a simplified piezoelectric pump.

FIGS. 10, 11, 12 and 13 illustrate simplified enlarged structures formed during fabrication of a gated electrochemical cell integrated with a logic module.

FIG. 14 is an enlarged illustration of a simplified printed circuit board with an integrated gated electrochemical cell/logic module.

FIG. 15 is a schematic illustration of a simplified chip including two integrated gated electrochemical cell/logic modules.

FIG. 16 is a simplified schematic illustration of a microelectronic system including multiple integrated gated electrochemical cell/logic modules.

FIG. 17 is a simplified schematic illustration of an electromechanochemical cell using inclusions and a non-conducting lattice.

FIG. 18 is a simplified schematic illustration of an electromechanochemical cell using a continuous medium.

FIG. 19 is a simplified schematic sectional illustration of a electrochemical cell using a gel-membrane.

FIG. 20 is a simplified schematic sectional illustration of a electrochemical half-cell and gate electrode.

FIG. 21 is a simplified schematic sectional illustration of an electrochemical cell with a graphite electrode.

FIG. 22 is a simplified schematic sectional illustration of an electrochemical complementary half-cell to convert stored energy to electrical.

FIG. 23 is a simplified schematic sectional illustration of an electrochemical half-cell showing option for semiconducting fluid.

### DETAILED DESCRIPTION

Embodiments of the present invention make use of the fact that integrated circuit domains in a microelectronic device may be operated with separate bias sources. The paradigm replaces the common ground approach with a common threshold. The only currents between domains are then the gate charging current. Leakage currents during transfer between high and low states is a local bias power factor and does not influence the signal path. Moreover, an individual bias source may be integrated with its corresponding integrated circuit domain, providing a source of bias that is available to the domain. Distributing multiple bias sources allows reduction or elimination of the power distribution and regulation system of the device, reducing or eliminating the space and power otherwise used by the power distribution and regulation system. Furthermore, each integrated circuit domain may be supplied with power only when necessary by virtue of the gating feature. In some embodiments, the bias sources are electrochemical cells, such as fuel cells. Alternatively, each domain power node may be connected to a pin, allowing each domain of the integrated circuit to be independently electrically supported by an external bias source or capacitor when appropriate.

The embodiments also include the development of an electrochemical fuel cell that may be switched on and off by applying a bias to the gate. Such an electrochemical cell may be a bias source for an integrated circuit domain, and may be integrated with the domain; both the bias source and the domain to which it is electrically connected may co-habit the same semiconductor substrate. By distributing multiple electrochemical cells as bias sources in a device, each integrated circuit domain may be supplied with power only when necessary, because the electrochemical cells may be switched on and off. The resulting chip, powered by distributed fuel cells, can operate with substantially reduced electrical noise, higher speed and less total power.

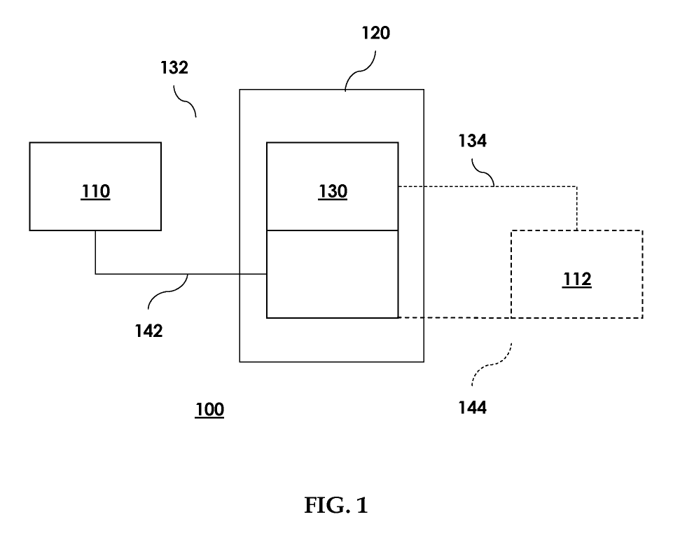

FIG. 1 is a simplified schematic illustration of an example of an electronic device 100 including a bias source 110 and an integrated circuit 120, which includes domains 130 and 140. Electronic device 100 may also include optional bias source 112. If bias source 110 is the only bias source in the device, domains 130 and 140 are independently electrically supported by the bias source through connections 132 and 142, respectively. If the device includes two bias sources, domain 130 may be connected to bias source 110 through connection 132, and domain 140 may be connected to bias source 112 through connection 144. Alternatively, domain 130 may be independently electrically supported by bias source 110 through connection 132 and independently electrically supported by bias source 112 through connection 134, and domain 140 may be independently electrically supported by bias source 110 through connection 142 and independently electrically supported by bias source 112 through connection 144.

The bias source may provide a portion of the bias required by the domain that is independently electrically supported by it, or it may provide all of the bias required. A baseline electric potential may be provided by another bias source. In one example, a baseline electric potential is provided by a primary power supply connected to the device. This level may preserve the state of the logic but not be sufficient for performing logical operations. In this example, the bias source may only need to provide an increase or decrease in the potential applied to a particular domain. In some embodiments, an electronic device includes a bias source corresponding to each domain in the integrated circuit. Alternatively, multiple bias sources may each be independently electrically connected to a plurality of domains, allowing individual domains to be biased by different bias source at different times. In another alternative arrangement, multiple domains may each be independently electrically connected to a plurality of bias sources. In a typical design, the electrochemical fuel cell may be sufficient for the average current to bias the domain and an external capacitor may be provided that will assume the load under certain circumstances for example a memory block might justify such an arrangement.

A bias source can be any source of electrical potential. Electrical potential sources include, for example, generators and electrochemical cells. Examples of electrochemical cells include batteries and fuel cells. For an electronic device that includes more than one bias source, the individual bias sources may be of the same type, or they may be of different types. In some embodiments, the bias source is small, lightweight and has a long operational lifetime. However, it should be understood that the general inventive principals are capable of being scaled to any desired size. An important feature is if it is integral to the logic of the chip and can be optimized by a compiler.

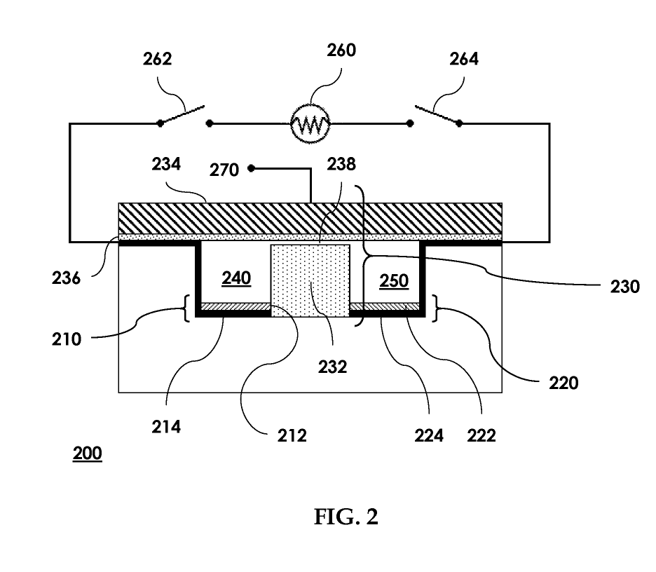

The bias source may be a fuel cell. Fuel cells can operate continuously for an indefinite period of time, provided that fresh reagent is supplied to each half-cell and that the electrodes 215 and 217, as shown in FIG. 2, are not consumed or contaminated. Microfluidic systems can be used to provide a flow of fresh reagent to the half-cells. The use of a digitally controlled fuel refreshment system incorporating a piezoelectric diaphragm pump, heat exchange, membranes for carbon dioxide, water and oxygen exchange with enough volume to act as a mixing reservoir allows the fuel cells to be supported in an optimized manner. The pump can be controlled to use several steps in each direction according to the volume of the plumbing on the chip. The digital control allows the same support module to power a very wide range of power levels and facilitates high volume, low cost.

An electrochemical cell consumes an oxidant and a reductant. Examples of oxidants for electrochemical cells include ozone, oxygen, fluorine, chlorine, bromine, iodine, metal salts and metal oxides that can be reduced to a lower oxidation state. For example, MnO₄— can be reduced to Mn²⁺ in the presence of a platinum catalyst in an acidic environment, consuming an electron.

Examples of reductants for electrochemical cells include sulfur, and metals, metal salts and metal oxides that can be oxidized to a higher oxidation state. For example, Fe²⁺ can be oxidized to Fe³⁺ in the presence of a platinum catalyst, producing an electron. Examples of reductants also include fuels, such as hydrogen or an oxidizable organic compound. In this example, the electrochemical cell is a fuel cell. In some embodiments, the electrochemical cell bias source is a fuel cell, and may use hydrogen, methanol or formic acid as the fuel.

FIG. 2 represents an example of a gated electrochemical cell 200 including an anode 210, a cathode 220, a membrane gate 230 between the anode and the cathode, a first conduit 240 contiguous with the anode 210 and one side of the membrane gate 230, and a second conduit 250 contiguous with the cathode 220 and the other side of the membrane gate 230.

The anode 210 includes an anode catalyst 212 and a conductive contact 214. The anode catalyst 212 includes a material that catalyzes the oxidation of a reductant. Examples of anode catalysts 212 include platinum, and combinations of platinum with ruthenium, tin, osmium or nickel.

The conductive contact 214 may be a conductive material, such as a metal, a conducting polymer, or doped polycrystalline silicon. The conductive contact 214 may be connected to an electric load 260 or to an optional switch 262 that can connect the conductive contact 214 and the electric load 260.

The first conduit 240 allows a fluid, such as a liquid, to flow in contact with the anode 210 and one side of the gate-controlled membrane 230. The fluid may include a reductant that is oxidized at the anode catalyst 212. The reductant may be hydrogen, or an oxidizable organic compound. Examples of oxidizable organic compounds include organic molecules having one or more carbons but not having adjacent alkyl groups, and where all carbons are either part of a methyl group or are partially oxidized. Examples of such oxidizable organic molecules include methanol, formaldehyde, formic acid, glycerol, ethanol, isopropyl alcohol, ethylene glycol and formic and oxalic esters thereof, oxalic acid, glyoxylic acid and methyl esters thereof, glyoxylic aldehyde, methyl formate, dimethyl oxalate, and mixtures thereof.

The cathode 220 includes a cathode catalyst 222 and a conductive contact 224. The cathode catalyst includes a material that catalyzes the reduction of an oxidant. Examples of cathode catalysts include platinum, and combinations of platinum with cobalt, nickel or iron, or the like.

The conductive contact 224 may be a conductive material, such as a metal, a conducting polymer, or doped polycrystalline silicon, or the like. The conductive contact 224 may be connected to an electric load 260 or to an optional switch 264 that can connect the conductive contact 224 and an electric load 260.

The second conduit 250 allows a fluid to flow in contact with the cathode 220 and the other side of the membrane gate 230. The fluid may include an oxidant that is reduced at the cathode catalyst 222. Examples of oxidants include ozone, hydrogen peroxide, permanganate salts, manganese oxide, fluorine, chlorine, bromine, iodine, and the like. The first and second conduits 240 and 250 may have the same dimensions, or they may have one or more dimensions that are different.

The fluids in conduits 240 and 250 during operation of the cell may be stationary, or one or both may flow. If the fluids are flowing, the flow rates and pressures may be the same or different. The flow in the conduits may be laminar, having minimal or no turbulence, the flow may be turbulent, or the flow may be switched between laminar and turbulent. In one example, the flow is turbulent at least part of the time during operation to regenerate the fluid composition in contact with the electrodes 215 and 217. The fluids in the conduits may independently flow in pulses. In one example, a flow pulse serves to regenerate the reactant concentration in the conduit, which is then depleted by reaction at the electrode. The flow may be pulsed again to bring fresh fluid into the conduit. This may be achieved with a digitally controlled pump. The structure shown may be achieved by etching a silicon wafer as part of a process in a silicon foundry or by stamping, rolling or pouring plastics and may be used to satisfy a wide variety of applications. The short distance between the electrodes provides a high energy density as the cell dimensions shrink and therefore adapt easily to matrix formats for high power.

In addition to including an oxidant or reductant, the fluids in the conduits 240 and 250 independently may include a carrier gas or liquid. A carrier liquid may contain one or more solvents, and optionally may contain one or more other components, such as a salt, a reaction mediator, an acid, a base, a stabilizer, a buffer, an electrolyte, and a viscosity modifier. The compositions of the carrier gases or liquids in each conduit may be the same or different.

The membrane gate 230 includes a solid structural material 232, a gate electrode 234, and a gate insulator 236 between the field effect material 232 and the gate electrode 234. In some embodiments the field effect material 232 will contact the gate insulator 236. An example of the field effect material would be silica gel wetted with electrolytes. The gate electrode 234 may be connected to an electric potential source 270 with respect to the electrodes 215 and 217 and reactants.

In other embodiments, the solid field effect material 232 will not contact the insulator 236 in which case the field effect material 238 may be any material having an ionic conductivity that can be changed by application of an electric field, for example water. The field effect material may be a single material, or it may be a composite material. For example, field effect material in the structured membrane slot 238 may include a substrate material that is unaffected by an applied electric field, for example silica gel and another material such as water that are in contact with the fluids in the electrochemical cell.

The field effect material 232 may be a structured field effect material, which includes one or more ion-conductive material channels connecting the conduits 240 and 250. The field effect material 232 may be a porous field effect material, which either may contact the gate insulator 236 or may be separated from the gate insulator.

A structured membrane may include a structured membrane slot 238 as the ion-conductive material channel, as represented in FIG. 2. The structured membrane slot 232 may extend for a portion or for the entire length of the conduits 240 and 250. The height dimension of the structured membrane slot 238 between the structured membrane and the gate insulator 236 is a fraction of the width dimension across the field effect material. The ion-conductive material channel of structured membrane slot 238 may have geometries other than a horizontal slot. In one example, a structured membrane includes one or more vertical slots between the conduits. A vertical slot may extend over part or all of the height of the conduits, and has a length dimension that is a fraction of its width dimension across the membrane. In another example, a structured membrane includes one or more capillaries between the conduits. A capillary has a length dimension and a height dimension that are fractions of the width dimension. The field effect material in these examples may or may not have a separation from the gate insulator 236. In one embodiment the structured membrane may be a sponge-like material such as porous silicon.

The gate electrode 234 is a conducting material, such as, but not limited to, a metal, a conducting polymer, or doped polycrystalline silicon. The gate electrode 234 is electrically connected to a switch that can apply an electric potential to the gate electrode 234.

The gate insulator 236 may include a dielectric material. Examples of dielectrics include silicon oxide, silicon oxynitride, silicon nitride, as well as high-K dielectric materials. The gate insulator 236 may be in contact with the field effect material 232, or there may be a slot 238 between the materials.

During the operation of gated electrochemical cell 200, a fluid including a reductant is present in the first conduit 240, and a fluid including an oxidant is present in the second conduit 250. The half-cell reaction of the reductant at the anode catalyst 212 produces electrons and an oxidized product. The electrons produced at the anode can travel through an external circuit to the cathode, where electrons react with the oxidant at the cathode catalyst 222 to produce a reduced product.

The gated electrochemical cell 200 may be turned on and off by switching the membrane gate 230 between conducting and non-conducting states. This switching may be accomplished by changing the electric potential of the gate electrode 234. At a first electric potential, the membrane gate 230 repels protons to a distance that is below the level of the structured membrane which therefore is deficient of mobile carriers and therefore conducts ions at a level that is too low to allow significant reaction at the electrodes. At a second electric potential, the gate permits or attracts a population of mobile carriers at the level of the structured membrane slot 238 and the structured membrane slot 238 conducts ions at a level sufficient to allow significant reaction at the electrodes 215 and 217.

As explanation for this change in ionic conductivity of the membrane gate 230, the carrier population near the gate will reverse with the polarity of the electric field applied by the gate electrode 234. This is similar to the formation of an inversion layer near the surface of a semiconductor substrate in a field effect transistor (FET). A change in the electronic properties of the field effect material 232 can modify the electronic properties of a liquid at or near a surface of the field effect material 232. If this liquid has sufficient highly mobile ion concentration, it can conduct ions between the first and second conduits 240 and 250, completing the path for the electrochemical cell.

For example, when an electric potential is applied to the gate electrode 234, the electronic properties of the slot 238, may change in response to the applied electric field because the holes, electrons, or ions concentrated in the top layer of the field effect material may move into the slot ion-conductive material, thereby providing an increased concentration of charge carriers in the structured membrane slot 238 between the two conduits 240 and 250 and allowing ions to flow between the liquids in the conduits 240 and 250. The ionic conductivity of the material in the structured membrane slot 238 is then changed, either increasing or decreasing its conductivity for anions and/or cations. As the height and/or length dimensions of the liquid extending between the conduits 240 and 250 decreases, the liquid may become more viscous or solid; however, the ion-conductive material may still conduct ions.

In another example, when an electric potential is applied to the gate electrode 234, holes, electrons, or ions concentrated in a porous field effect material 232 may move into the ion-conductive substances in the pores of the material, providing an increased concentration of charge carriers in the ion-conductive material between the two conduits and allowing ions to flow between the liquids in the conduits. The ionic conductivity of the ion-conductive material within the porous field effect material 232 is changed, either increasing or decreasing its ionic conductivity for anions and/or cations.

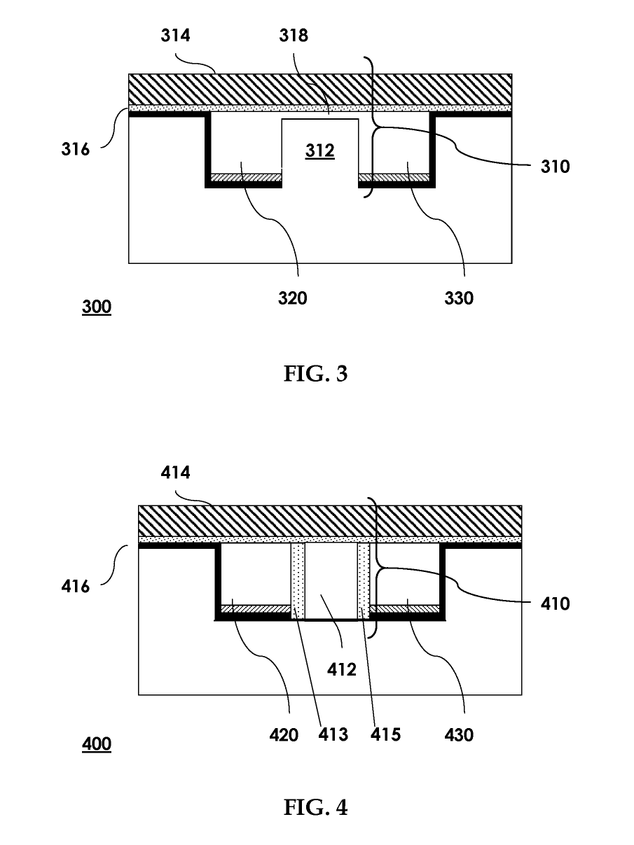

FIG. 3 represents an example of an electrochemical cell 300 having a membrane gate 310 that includes a structured membrane slot 318 filling the slot 318, a gate electrode 314, and a gate insulator 316. The field effect material 312 is separated by structured membrane slot 318 from the gate insulator 316. The structured membrane filling the slot 318 connects a liquid in a first conduit 320 with a liquid in a second conduit 330. The structured membrane surface may be doped with P- or N-type dopants.

FIG. 4 represents an example of a gated electrochemical cell 400 having two structural membranes 413, 415 including a third conduit 412, a gate electrode 414, and a gate insulator 416. The conduit 412 may be filled with any suitable fluid such as, but not limited to, water and be able to receive fuel molecules from one side and oxidant from the other side without becoming significantly contaminated because the flow of the fluid such as water is sufficient to carry away the amounts reaction products that diffuse across the membrane. The central conduits 412 will more fully isolate the electrodes 417 and 419 when the gate electrode 414 repels protons but will not be lossy when the protons are attracted to the gate. The membrane gate 410 may completely separate a first conduit 420 from a second conduit 430.

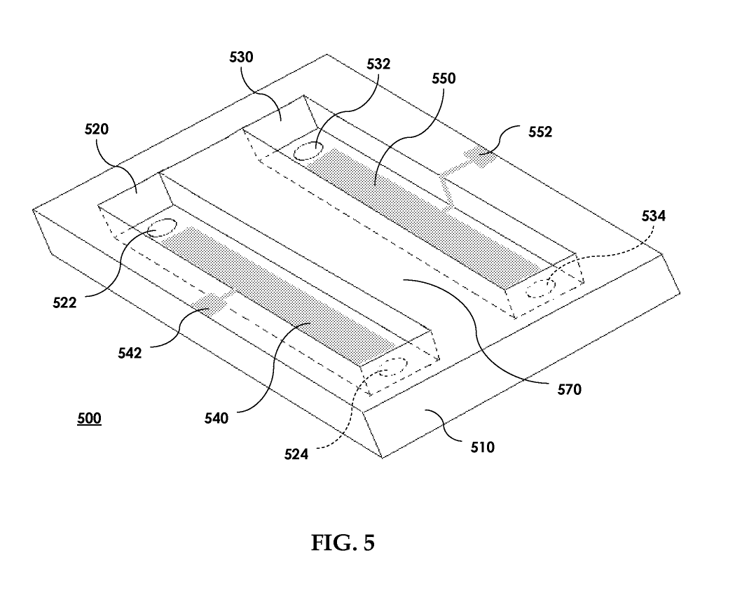

FIG. 5 represents a perspective view of a partially constructed gated electrochemical cell 500. Partially constructed gated electrochemical cell 500 includes a substrate 510, two conduits 520 and 530, an anode 540, a cathode 550, and a separator/membrane 570. Conduit 520 includes an inlet 522 and an outlet 524, and conduit 530 includes an inlet 532 and an outlet 534. Anode 540 and cathode 550 are electrically connected to contacts 542 and 552, respectively. The anode and cathode may be located on the bottoms and/or on the sides of the conduits. The anode and cathode may intersect the inlets and/or the outlets, or a material making anode 540 and cathode 550 may be configured not to contact the inlets 522 and 532 and outlets 524 and 534. Membrane/separator 570 may be a structural material or a porous material. Structure 500 may be combined with a cap layer to form an electrochemical cell which may be gated in some configurations

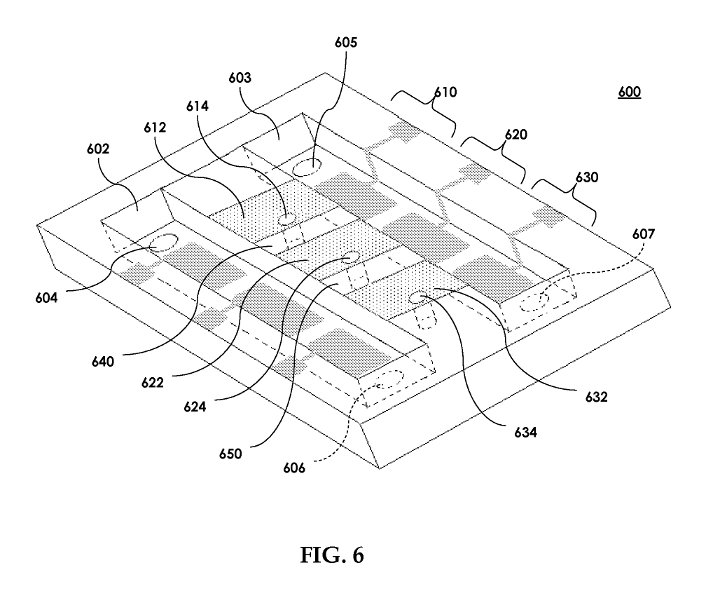

FIG. 6 represents a perspective view of a partially constructed electrochemical cell system 600 including individual electrochemical cells 610, 620 and 630, each of which are connected to conduits 602 and 603. As shown in FIG. 6, individual gated electrochemical cells 610, 620, and 630 may be configured to share a common set of conduits 602 and 603. Electrochemical cell 610 includes field effect material 612, electrochemical cell 620 includes field effect material 622, and electrochemical cell 630 includes field effect material 632. The field effect materials 612, 622 and 632 may be separate materials, or they may be integral. The conduits 602 and 603 contain inlets 604 and 605, and outlets 606 and 607, respectively.

The individual electrochemical cells 610, 620 and 630 may be separated by isolation regions 640 and 650, such that the on or off status of one of the electrochemical cells 610, 620, and 630 does not affect the status of the other electrochemical cells 610, 620, and 630. The isolation regions 640 and 650 may be formed as part of the patterned etching of the field effect material 612, 622, and 632 and/or the conduits 602 and 603, or the isolation regions 640 and 650 may be formed separately. Each electrochemical cell 610, 620, and 630 may also include vias 614, 624 or 634 through the field effect material 612, 622, and 632 near the isolation regions 640 and 650 or near the outlets 606 and 607. These vias can drain liquid from the space above the field effect material, which may help to remove reaction products and replenish the liquid between the conduits 602 and 603.

Gated electrochemical cells may be formed using standard semiconductor processing techniques. Examples of processes in semiconductor manufacturing include lithography, etching, polishing, chemical vapor deposition (CVD), and physical vapor deposition (PVD). Semiconductor processes for use in the present invention are well known to those of ordinary skill in the art, and are also described in Encyclopedia of Chemical Technology, Kirk-Othmer, Volume 14, pp. 677-709 (1995); Semiconductor Device Fundamentals, Robert F. Pierret, Addison-Wesley, 1996; Wolf, Silicon Processing for the VLSI Era, Lattice Press, 1986, 1990, 1995 (vols 1-3, respectively); Microchip Fabrication 4th. edition, Peter Van Zant, McGraw-Hill, 2000.

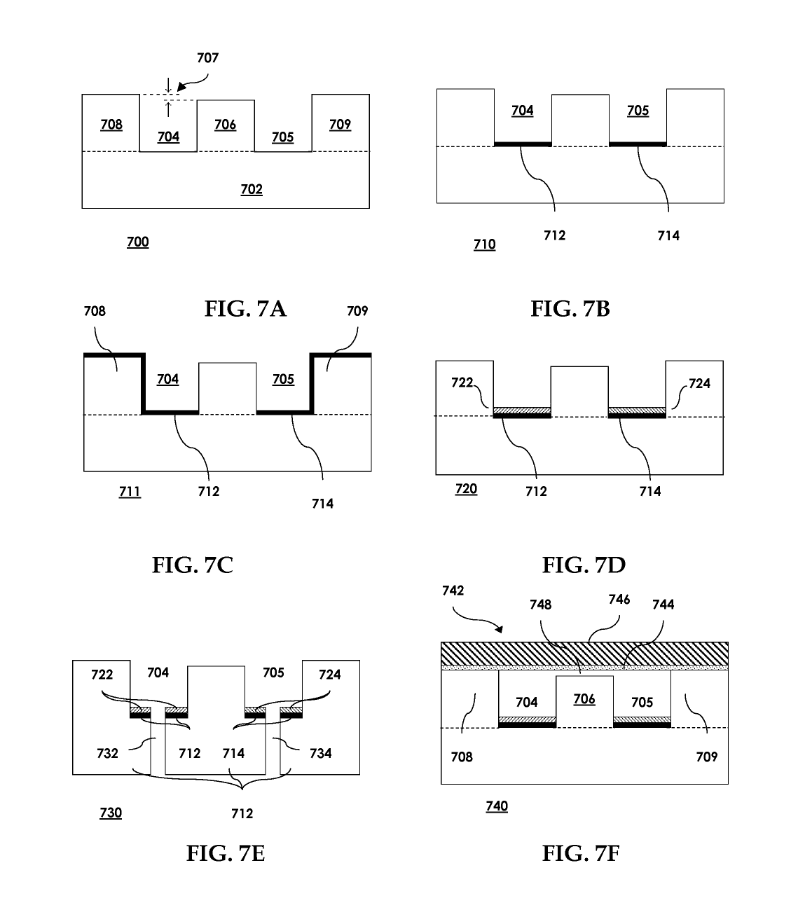

FIGS. 7A to 7F represent structures formed during an example of a method of making a gated electrochemical cell. In FIG. 7A, structure 700 includes a substrate 702, two conduits 704 and 705, an intermediate region 706 between the two conduits, and walls 708 and 709. The intermediate region 706 has a difference in height 707 relative to the height of the walls 708 and 709.

The substrate 702, intermediate region 706, and walls 708 and 709 may be integral, they may be the same material, or they independently may be different materials. In one example, the substrate 702 and walls 708 and 709 are insulators, and the intermediate region 706 is a semiconductor. In another example, the substrate 702 and intermediate region 706 are semiconductors, and the walls 708 and 709 are insulators. In another example, the substrate 702, walls 708 and 709 and intermediate region 706 are integral. In another example, the substrate 706, walls 708 and 709 and intermediate region 706 are integral and are formed from a single semiconductor substrate. Semiconductor materials may be doped or undoped, and the doping may be uniform, or it may vary depending on the location within the material. The intermediate region 706 may be a semiconductor. The intermediate region 706 may be a field effect material, or the intermediate region 706 may be converted to a field effect material through doping, or chemical reaction. In the case of logic and fuel cells on a single substrate 702 it is appropriate that the divider is silicon but, in the case of where the fuel cell is formed from plastics or organic material, the options for the divider can be much broader.

Structure 700 may be formed from a single semiconductor substrate 702, for example by micromachining or by lithographic techniques. In an example of a lithographic method, the intermediate region 706 and conduits 704 and 706 together are three minimum line-widths wide (minimum line-width is also referred to as critical dimension or CD). The depth of the intermediate region 706, corresponding to height difference 707, may be from 0.01 to 0.2 times the depth of the conduits 704 and 706.

In FIG. 7B, structure 710 includes conductive layers 712 and 714 in each conduit 704 and 705, respectively. The conductive layers 712 and 714 may also be on at least a portion of the walls to facilitate a connection between the conductive layers 712 and 714 and an external switch 262 and 264 or load 260 as shown in FIG. 2. This is illustrated in FIG. 7C, where structure 711 includes conductive layers 712 and 714 on walls 708 and 709. In FIG. 7D, structure 720 includes an anode catalyst 722 and a cathode catalyst 724 on the conductive layers 712 and 714, respectively.

To form inlets and outlets for a conduit, vias may be formed at each end of the conduit. In FIG. 7E, structure 730 includes vias 732 and 734 in conduits 704 and 705. The vias may be formed at any point in the fabrication process. The vias may intersect the electrode layers (712, 714) and/or the catalyst layers (722, 724) as shown, or they may only contact the substrate 702.

In FIG. 7F, structure 740 includes a cap layer 742 that is bonded to the walls 708 and 709 and that extends over the conduits 704 and 705 and the intermediate region 706. The cap layer 742 includes an insulating layer 744 and a conducting layer 746, and is separated from the intermediate region by slot 748. Structure 740 can be a gated electrochemical cell having a membrane gate that includes a structural field effect material.

In one example, the cap layer 742 may be formed by first depositing a tenting resist film over structure 720 and/or 730, such that the film contacts the walls 708 and 709 but does not contact the intermediate region 706. The resist film can be etched in a pattern to expose features such as electrical contact areas or dicing lines. An insulating layer may be formed on the resist film, or the resist film can be the insulating layer. A conducting layer can then be deposited to complete the cap layer 742. In another example, the cap layer 742 may be formed in a separate process and then contacted with the walls 708 and 709. A sealant such as a glop-top layer may be applied to some or all of structure 740, to ensure that the electrochemical cell can sustain the fluid pressures experienced during operation.

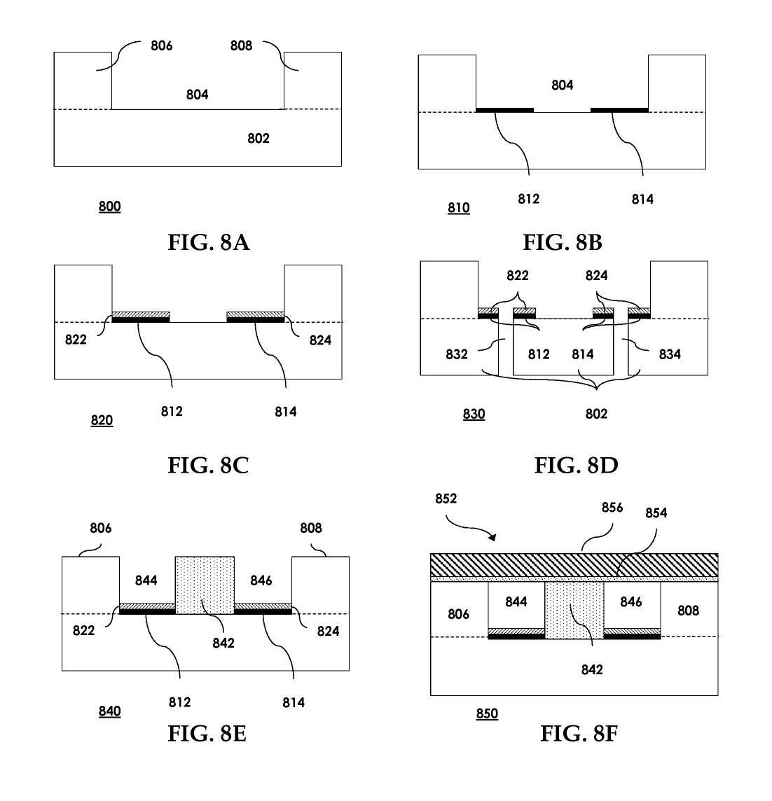

FIGS. 8A to 8F represent structures formed during another example of a method of making a gated electrochemical cell. In FIG. 8A, structure 800 includes a substrate 802 and a trench 804 having walls 806 and 808. The substrate 802 and walls 806 and 808 may be integral, they may be the same material, or they independently may be different materials. In one example, the substrate 802 and walls 806 and 808 are insulators. In another example, the substrate 802 is a semiconductor, and the walls 806 and 808 are insulators. In another example, the substrate 802 and walls 806 and 808 are integral. In another example, the substrate 802 and walls 806 and 808 are integral and are formed from a single semiconductor substrate, for example, by micromachining or by lithography. Semiconductor materials may be doped or un-doped, and the doping may be uniform, or it may vary depending on the location within the material.

In FIG. 8B, structure 810 includes conductive layers 812 and 814 on two separate portions of the trench 804. In FIG. 8C, structure 820 includes an anode catalyst 822 and a cathode catalyst 824 on the conductive layers. In FIG. 8D, structure 830 includes vias 832 and 834 in the semiconductor substrate 802. These vias may provide inlets and outlets for the conduits, and may be formed at any point in the fabrication process. The vias may intersect the electrode conductive layers (812, 814) and/or the catalyst layers (822, 824) as shown, or they may only contact the substrate 802.

In FIG. 8E, structure 840 includes a porous field effect material 842 between the anode catalyst 822 and conductive layer 812, and the cathode catalyst 824 and conductive layer 814. Conduits 844 and 846 are thus formed between the porous field effect material 842 and the walls 806 and 808. In FIG. 8F, structure 850 includes a cap layer 852 that is bonded to the walls 806 and 808 and that extends over the conduits 844 and 846. The cap layer 852 may contact the porous field effect material 842, or there may be a space between them. The cap layer 852 includes an insulating layer 854 and a conducting layer 856. Structure 850 can be a gated electrochemical cell having a membrane gate that includes a porous field effect material.

In one example, the cap layer 852 may be formed by first depositing a tenting resist film over structure 840, such that the film contacts the porous field effect material 842 and walls 806 and 808. The resist film can be etched in a pattern to expose features such as electrical contact areas or dicing lines. An insulating layer 854 may be formed on the resist film, or the resist film can be the insulating layer 854. A conducting layer can then be deposited to complete the cap layer 852. In another example, the cap layer 852 may be formed in a separate process and then contacted with the porous field effect material 842 and walls 806 and 808. A sealant such as a glop-top layer may be applied to some or all of structure 850, to ensure that the electrochemical cell can sustain the fluid pressures experienced during operation.

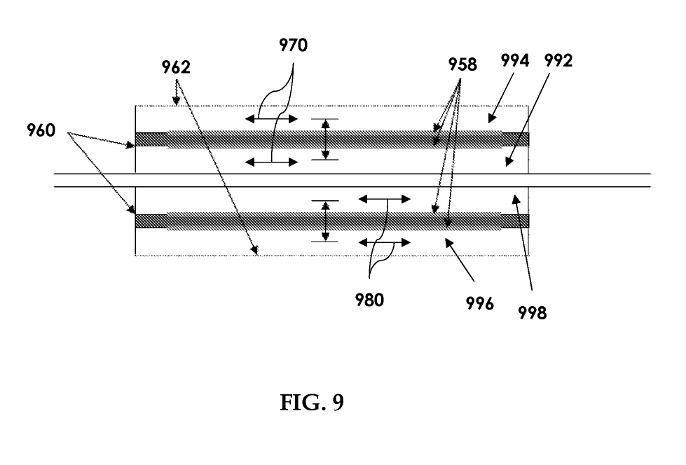

FIG. 9 illustrates a simplified schematic and diagrammatic illustration of a microfluidic system 900 wherein two piezoelectric pumps 902 and 904. Piezoelectric pump 902 pumps reactants held in reservoir 906 though piezoelectric pump 902 to gated electrochemical cell 908. A gated electrochemical cell may be supplied with reactants by a microfluidic system. A microfluidic system 900 may include several different reservoirs for the liquids containing a reductant and an oxidant, microfluidic channels 910, 912, 914, and 916 for reactants and waste products, and pumps 902 and 904 to induce liquid flow into and out of the channels 910, 912, 914, and 916. Microfluidic system 900 may include additional components, such as one or more flow control devices 918, a recycling system illustrated by pump 904, and temperature controls 920. In this particular illustration of an embodiment of micro-fluidic system 900, micro-fluidic system 900 may include a microfluidic channel 910 that directs fluid from a reservoir 906 to a coupling 922 of pump 902. Pump 902 moves the fluid though coupling 924, wherein the fluid from reservoir 905 is ported into channel 912 and flows though coupling 926 to gated electrochemical cell 908. After the reactants have been reacted and turned into reaction products, the resulting fluid from gated electrochemical cell 908 are passed though coupling 928 of gated electrochemical cell 908 collects reaction products and moves the reaction products though channel 914 and moved to coupling 930. The fluid is subsequently pumped though pump 904 and though coupling 932 into channel 916 and into waste receptacle 934 in the conduit 910 in a gated electrochemical cell 807. The micro-fluidic system 900 may also include a micro-fluidic channel that directs fluid from an outlet in a gated electrochemical cell conduit to a waste receptacle or to a recycling system.

As shown in FIG. 9, microfluidic system 900 can be formed by using a substrate 936 having two sides 940 and 942. Electrochemical cell 908 is attached to side 940. It should be understood that registration of the two electrochemical cells 908 substrates to each other can provide for alignment of the inlet vias 604 and 605 and outlet vias 606 and 607 as shown in FIG. 6 with the corresponding microfluidic channels for the reductant inlet, reductant outlet, oxidant inlet and oxidant outlet. The micro-fluidic system 900 may be formed in the substrate of the gated electrochemical cell. For example, the microfluidic channels may be formed on one side of a substrate 936, and the trench or conduits for the electrochemical cell may be formed on the other side of the same substrate 936, or on the same side of substrate 936.

Access to consecutive conduits that are stacked of electrochemical cells can be achieved by etching vias 832 and 834 through substrate 802 and/or by forming openings through the cap layer 852. In one example, the inlets to the two conduits 844 and 846 pass through the cap layer 852, and the outlets from the two conduits pass through the substrate. In this example, the microfluidic supply channels are above the electrochemical cell, and the microfluidic return channels are below the electrochemical cell. In another example, the inlet and outlet for one of the conduits pass through the cap layer 852, and the inlet and outlet for the other conduit pass through the substrate. In this example, the microfluidic channels for each reactant are on opposite sides of the electrochemical cell. In another example, all of the microfluidic channels are on one side of the electrochemical cell and have access to the appropriate conduits through vias in the substrate.

Examples of pumps include mechanical pumps and piezoelectric pumps. Mechanical pumps include, for example, syringe pumps and pistons. By way of example only, FIG. 9 illustrates an example of a piezoelectric pump 900 for a microfluidic system.

A flow control device 918 may be present in a microfluidic system to control the amount and/or direction of fluid flow. Flow control devices may be especially useful in a microfluidic system that processes fluid for more than one set of conduits. Examples of flow control devices include, but are not limited to, solenoid valves, and piezoelectric valves.

As shown in FIG. 900, a recycling system 944 may be present in a microfluidic system to isolate reaction products or contaminants from the reactant fluids. Each fluid from the conduit outlets may have a dedicated recycling system, or the two fluids may share a common recycling system. An electrochemical cell 908 may be operated such that one or both of the reactants is completely consumed during the cell reaction, such that the exiting fluid includes only carrier gas or liquid that can be directed back to a fluid reservoir. In addition, fluid that may drain directly from the slot of an electrochemical cell having a structured field effect material may be recycled, vented, or directed to a waste receptacle 934. If the slot liquid is recycled, it may have a dedicated recycling system, or it may share a recycling system with one or both of the conduit fluids.

Temperature controls 912 may be present in a microfluidic system to dissipate heat that may build up in the fluids. The temperature of a fluid in a gated electrochemical cell may increase due to an exothermic reaction between the reactants and the catalyst. The temperature of a fluid in a gated electrochemical cell may increase due to the electrical dissipation in a load connected to the cell.

In one example, the fluid temperature may be controlled by a heat exchanger. For example, microfluidic channels may pass through a thermally conductive material, which may be configured with plates that allow heat to be radiated to the surrounding environment.

A gated electrochemical cell may be connected to a semiconductor structure or a semiconductor device. When the structure or device is accessed in a processing operation, the power required to operate the structure or device may be provided at least in part by the electrochemical cell.

One or more semiconductor structures may be formed on the same semiconductor substrate as a gated electrochemical cell.

One or more semiconductor structures may be formed in a stacking arrangement with a gated electrochemical cell. For example, a gated electrochemical cell may have a cap layer 852 that is sufficiently flat to allow for further semiconductor processing. The top portion of the cap layer 852 thus becomes the substrate for forming one or more semiconductor structures.

The following examples are provided to illustrate one or more embodiments of the invention. Numerous variations may be made to the following examples that lie within the scope of the invention.

### EXAMPLES

### Example 1

### Fabrication of a Gated Electrochemical Cell Integrated with a Logic Module

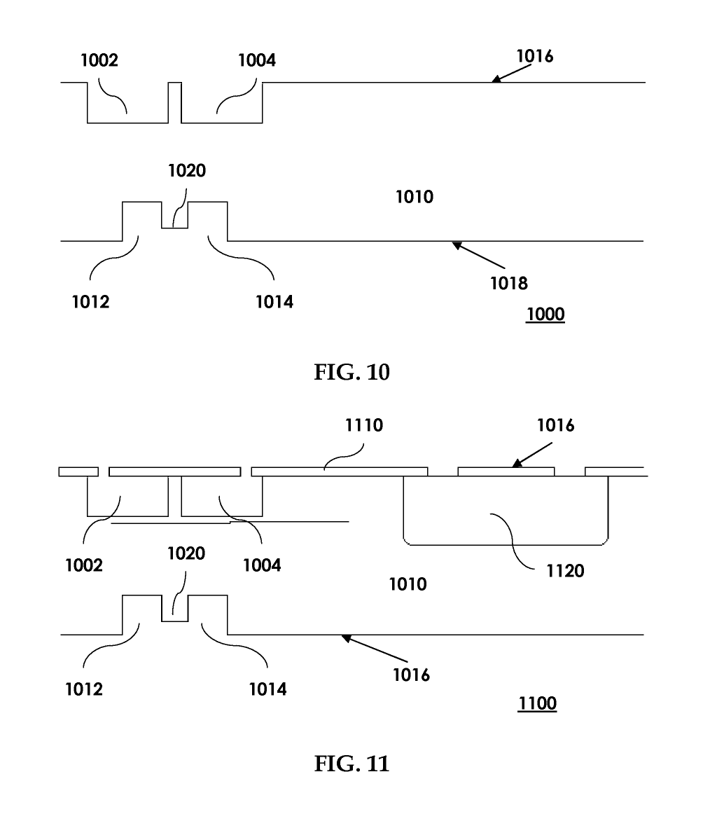

Shown in FIG. 10, a silicon wafer 1010 is etched on both sides 1016 and 1018, respectively, with different patterns 1006 and 1008, respectively. On side 1016, pattern 1006 corresponds to microfluidic channels 1002 and 1004 or a microfluidic network. Separate microfluidic channels 1002 and 1004 are formed for reductant inlet, reductant outlet, oxidant inlet, oxidant outlet, and mixed liquid drain. On the other side 1018, pattern 1008 corresponds to pairs of conduits 1012 and 1014 for one or more electrochemical cells which are shown partially fabricated, and an intermediate region 1020 between the conduits 1012 and 1014. A depth and a width dimension of conduits 1012 and 1014 independently are between 10 and 200 microns. Intermediate region 1020 has a width on the order of the conduit widths, and a depth of from 20 nanometers to 5 microns. The etching may be performed using semiconductor fabrication techniques, micromachining, or the like. FIG. 10 is a simplified illustration of a structure 1000 that includes wafer 1010 in which microfluidic channels 1002 and 1004, conduits 1012 and 1014, and an intermediate region 1020 have been formed.

A logic module 1120 containing one or more transistors is formed on side 1016 of wafer 1010 containing the microfluidic network 1005. A tenting resist film is applied over the microfluidic network and the logic module 1120. The tenting resist is patterned to provide fluid access to the microfluidic network 1005 and to provide electrical access to the logic module 1120. The logic module 1120 and patterned tenting resist film are formed using conventional semiconductor processing techniques. FIG. 11 is a simplified illustration of a structure 1100 that may be formed from structure 1000 as shown in FIG. 10. Structure 1100 includes wafer 1010, microfluidic channels 1002 and 1004, conduits 1012 and 1014 separated by intermediate region 1020, patterned tenting resist film 1110, and logic module 1120.

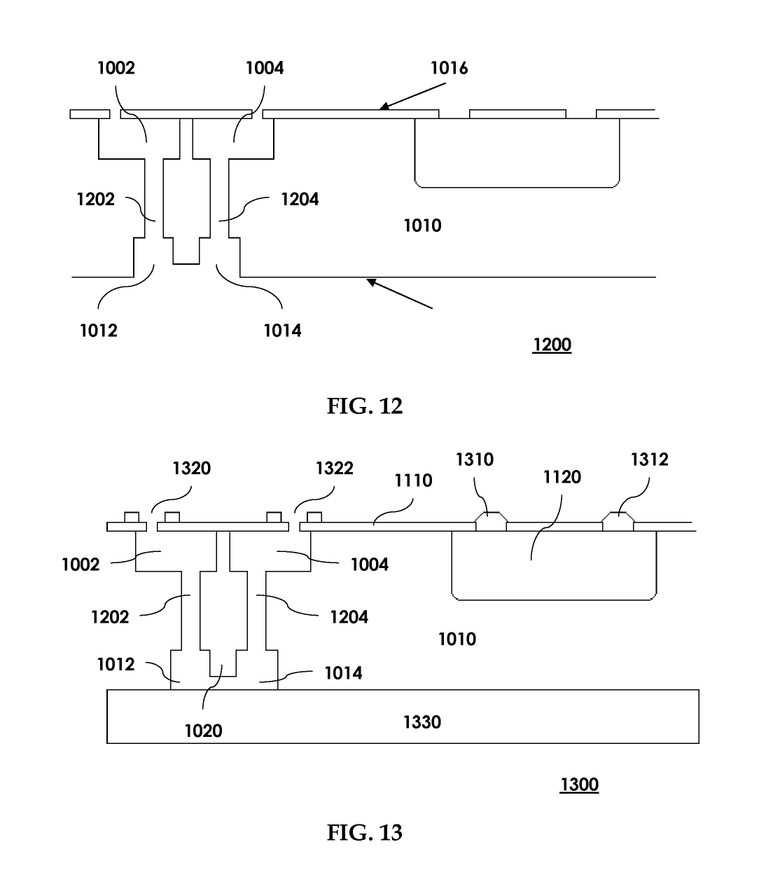

A photo-resist layer is applied to the conduit side of the wafer. The photo-resist layer is patterned, and then vias are etched from the conduits 1012 and 1014 to the microfluidic channels 1002 and 1004. These vias can provide fluid inlets and outlets to the conduits 1012 and 1014. FIG. 12 is a simplified illustration of a structure 1200 that may be formed from structure 1100. Structure 1200 includes vias 1202 and 1204 through wafer 1010, connecting microfluidic channels 1002 and 1004 with conduits 1012 and 1014, respectively.

Side 1016 of the wafer 1010 is again covered with a patterned photo-resist. A layer of nickel is formed on the base of each conduit 1012 and 1014 between the inlet and outlet vias, and extends out of the conduits to form interconnect areas. Another patterned photo-resist is formed, and a gold layer is deposited by electrolysis onto portions of the nickel layer, forming the electrode areas in the base of each conduit 1012 and 1014. A platinizing solution containing 3 grams of chloroplatinic acid and 0.02 grams of lead acetate in 100 grams of distilled water is then contacted with each electrode (not shown), and a layer of black platinum is formed. The photo-resists are removed to provide the an anode and a cathode in the conduits 1012 and 1014.

Referring now to FIG. 13, the assembly of the electrochemical cell is completed by bonding the side 1016 of the wafer 1010 having the conduits 1012 and 1013 to a substrate 1010. The conduits 1012 and 1013 are sealed, with the only inlets and outlets located at the vias 1202 and 1204. Solder bumps 1310 and 1312 are formed on the resist openings above the logic module 1120 by flip-chip application. The resist openings above the microfluidic channels 1002 and 1004 are surrounded with low temperature port connect rings by jet printing a thermosetting paste. The rings solidify to become connecting tubes to mounting inlet and outlet tubes. FIG. 13 is a simplified illustration of a structure 1300 that may be formed from structure 1200. Structure 1300 includes wafer 1010 having microfluidic channels 1002 and 1004, conduits 1012 and 1014, vias 1202 and 1204, and intermediate region 1020; patterned tenting resist film 1100; logic module 1120; solder bump connects 1310 and 1312; fluid connects 1320 and 1322; and cap layer 1330

### Example 2

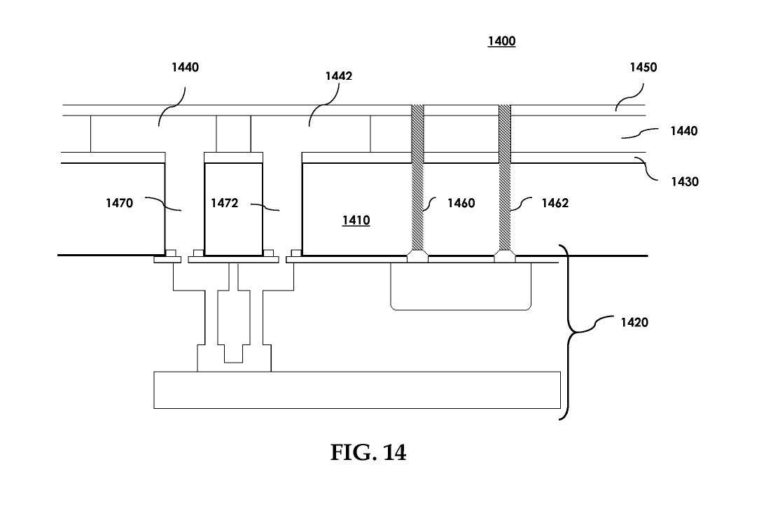

### Combination of a Printed Circuit Board 1410 with an Integrated Gated Electrochemical Cell/Logic Module as Shown in FIG. 14.

Gated electrochemical cells, such as the cell formed in Example 1, are connected to a microfluidic network and used to provide power to their integrated logic modules 1120. The process of Example 1 may be used to form multiple integrated electrochemical cells and associated logic modules 1120, and a single substrate containing one or more of these integrated electrochemical cell/logic modules 1120 is referred to as a “chip.” One or more chips may be mounted to a printed circuit board 1410.

Once the conventional layers of metal on printed circuit board 1410 have been processed, such as by etching and through-hole plating, a patterned protective layer 1430 is applied in the form of a conformal coating or a film-type photosensitive elastomer and then cured to a hard refractory surface. To produce channels 1442 and 1444 for the reactant liquids, a second layer of material is applied to patterned protective layer 1430 and then selectively removed to make fluid channel layer 1440. The pattern of patterned protective layer 1430 includes the fluid channels, e.g., channels 1442 and 1444, as well as openings for electrical contacts 1460 and 1462. A top layer 1450 is then formed over fluid channel layer 1440 by any suitable means or method such as, but not limited to, deposition of a tenting resist film to seal the fluid channels. The top layer 1450 is patterned to provide openings for the electrical contacts 1460 and 1462. Fluid contacts 1470 and 1472 are formed through the circuit board 1410 to the microfluidic network. Chip 1420 may be connected to the printed circuit board 1410 by aligning the fluid channels 1442 and 1444 and bump contacts 1310 and 1312 of the chip 1420 with the electrical contacts 1460 and 1462 and fluid contacts 1470 and 1472 of the printed circuit board 1410. It should be understood that chip 1420 is an example of a single chip 1420 and that a plurality of chips 1420 can be mounted to printed circuit board 1410.

FIG. 14 is a simplified illustration of a structure 1400 including a printed circuit board 1410 connected to a chip 1420, a patterned protective layer 1430, a fluid channel layer 1440, and a top layer 1450. Electrical contacts 1460 and 1462 extend through the layers and the printed circuit board 1410 to connect to the logic module of the chip 1420. Fluid contacts 1470 and 1472 provide two of the fluid connections between fluid channels 1442 and 1444 with the microfluidic network of the chip 1420.

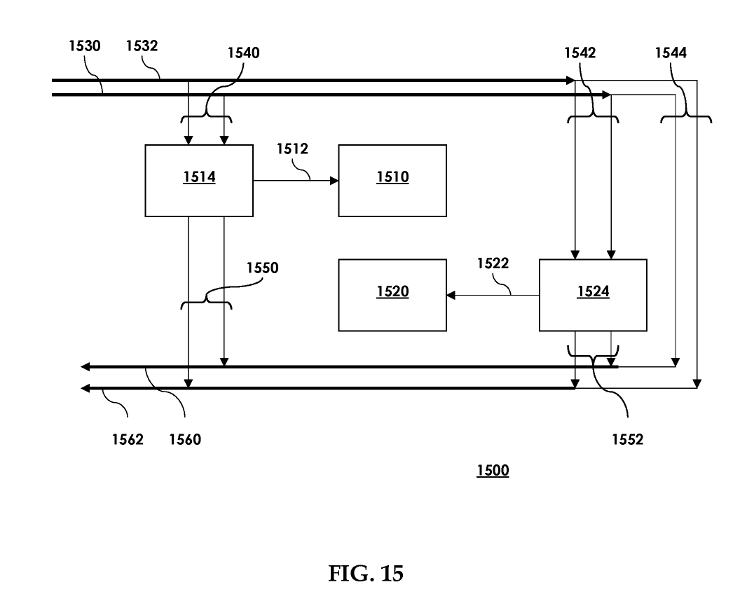

FIG. 15 is a simplified schematic representation of a chip 1500 including two logic modules 1510 and 1520 independently powered through electrical connections 1512 and 1522 by integrated electrochemical cells 1514 and 1524, respectively. The reductant and oxidant are directed to the microfluidic network of the chip 1500 under a regulated absolute pressure through fluid contacts 1530 and 1532, respectively. Microfluidic channels on the chip 1500 split to form [three] several pairs of streams, each pair including a reductant stream and an oxidant stream. Inlet pairs 1540 and 1542 are each directed to a separate electrochemical cell. Pair 1544 is directed through a pattern under the chip to collect heat and to establish the desired pressure drop. Outlet pairs 1550 and 1552 from the electrochemical cells are combined with pair 1544, and the used reductant and oxidant liquids are removed from the chip through fluid contacts 1560 and 1562.

### Example 3

### Self-Contained Gated Electrochemical Cell/Logic Module System

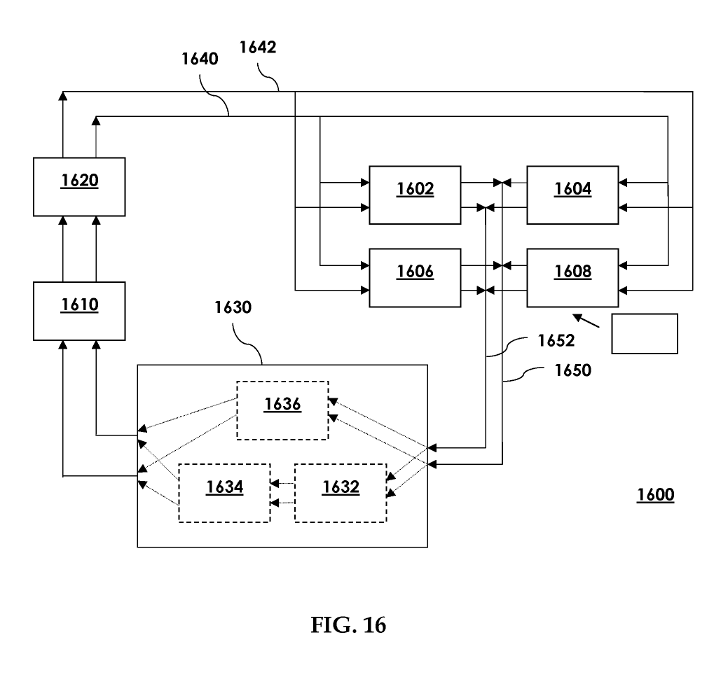

FIG. 16 is a simplified schematic illustration of a self-contained gated electrochemical cell having a logic module system. A circuit board containing one or more chips, such as the circuit board formed in Example 2, is connected to a microfluidic system to provide a fully functional, self-contained microelectronic system. FIG. 16 is a simplified schematic representation of a microelectronic system 1600 including a plurality of chips 1655 illustrated by multiple chips 1602, 1604, 1606 and 1608; reservoir 1610; pump 1620; recycler 1630; fluid channels 1640 and 1642; and microfluidic outlet channels 1650 and 1652.

A reductant liquid stream and an oxidant liquid stream are produced from reservoir 1610 by pump 1620. The reservoir 1610 and pump 1620 each include separate components for processing the reductant liquid and the oxidant liquid. The pump 1620 is powered by an external power supply (not shown), such as a battery, an alternating current source, or a separate electrochemical cell. Once one or more of the chips (1602, 1604, 1606, 1608) is switched on to produce an electric current, the pump 1620 is powered at least in part by the electrochemical cells of the chips (1602, 1604, 1606, and 1608). The reductant liquid and the oxidant liquid are directed to one or more of the plurality of chips 1610 through fluid channels 1640 and 1642, respectively. The pressure of each liquid is regulated to be a standard operation pressure that stabilizes the delivery rates of the reactants to one or more of the plurality of chips 1655. Each of the inlet channels 1640 and 1642 are split into separate microfluidic inlet pairs for each chip 1602, 1604, 1606, and 1608, such that each inlet pair has the same pressure drop.

After passing through the electrochemical cell conduits in one or more of the plurality of the chips 1655, the liquids are directed away from one or more of the plurality of the chips 1655 through microfluidic outlet pairs, which are combined into outlet channels 1650 and 1652. The outlet channels direct the liquids to the recycler 1630. The recycler 1630 separates the carrier liquid, reaction products and/or residual reactants from the liquid streams. The recycler 1630 may include optional evaporator 1632 to selectively separate gas phase components from the liquids. Gas phase from the evaporator is processed by optional gas chromatograph 1634, to isolate components such as water, carbon dioxide, and residual reactants. The recycler 1630 may include optional liquid chromatography system 1636, which includes one or more liquid chromatographs for separation of the components of the liquid. The waste components of the outlet liquids are either vented or directed to a waste receptacle. Any reactants that have crossed over, for example reductant in the oxidant liquid or oxidant in the reductant liquid, are separated and recombined with the appropriate liquid. There may be a stabilization period at startup when contamination in the liquids will increase before the purification process begins to be effective. The carrier liquids and residual reactants are directed back to the reservoir 1610. The reservoir 1610 may serve as a heat exchanger for the liquids, dissipating excess heat from the liquids prior to re-circulating the liquid through the microelectronic system 1600.

It should be understood that it is also possible to construct all of the fuel cell conduits and components on one side of the wafer and all of the logic on the other. This greatly simplifies the processing of the logic.

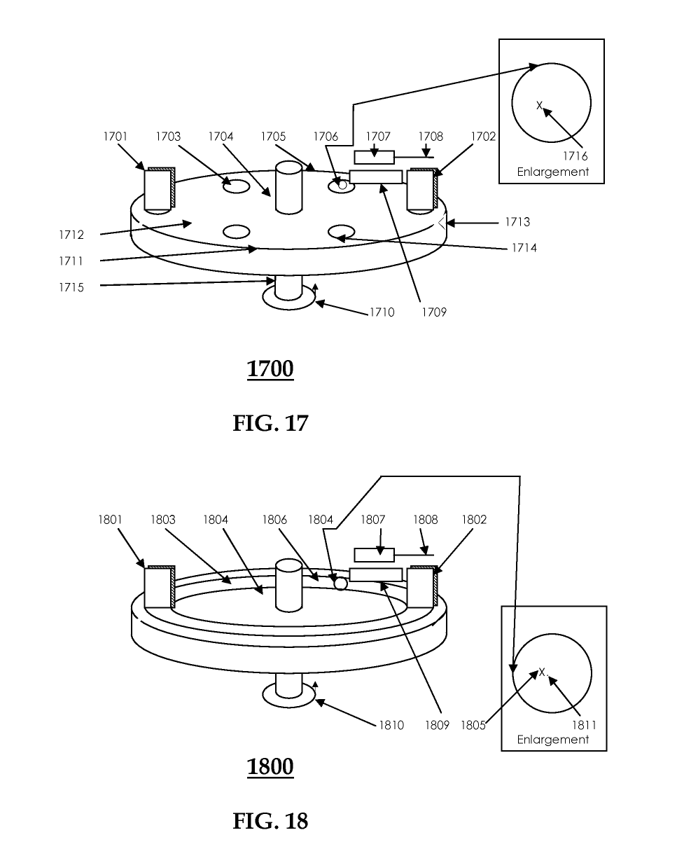

FIG. 17 is a simplified illustration of a fuel cell system 1700. Fuel cell system 1700 includes a first electrode 1701, a second electrode 1702, an ion-hosting inclusion 1703, an ion transfer platform 1704, a non-conducting lattice 1705, an ion or a site wherein an ion may be hosted 1706, an ion resident in the ion-hosting site 1716, a gate electrode 1707, an independent electrical potential 1708, a gate insulator 1709, a rotating table 1711, a top surface 1712 having thickness 1713 with openings 1714, rotating axel 1715 and an input for rotational mechanical energy 1710.

In general, ion hosting platform 1704 is made of non-conductive or dielectric material formed as a rotating table 1711 with a top surface 1712 and a thickness 1713 with openings 1714 being partially cut into surface 1712 and into thickness 1713 of rotating table 1711. Rotational movement is applied to rotating table by rotating axel 1715. Openings 1714 are made partially into table 1711, thereby providing a container for a liquid, gel, porous medium or solid inclusion having selected properties. However, it should be understood that other kinds of containers could be used as well. The table is only as an example and could be equally replaced by a belt or, a number of vibrating reeds moving between the first electrode and the second electrode.

Generally, the openings 1714 are filled with an electrolyte solution such as, but not limited to, an acid such as sulfuric acid (H₂SO₄), formic acid, or the like. Sulfuric acid will mostly ionize into (2H⁺+SO₄⁻²). Formic acid can be used as a fuel and may be used for other reasons. Alternatively, the openings 1714 can contain alkali with reducing components.

When the electrolyte solution-filled opening of 1714 is in contact with the first electrode 1701 additional protons may diffuse into the electrolyte solution. Generally, each additional proton will tend to join the two around an (SO4)⁻² core forming an (3H⁺+SO4⁻²)⁺ ion group. Because these ion groups are now charged, there will be a field that will distort the neighboring water molecules in a way that will distribute the charge associated with individual ions of the ion groups. The distortion will amount to dipolar molecules shifting their orientation so as to maintain a general potential of the electrolyte solution that will impart a net positive charge to the electrolyte solution. As other protons form similar ion groups, they each cause a charge disturbance and tend to repel one another by electrostatic forces. These surplus positive ions can only migrate through the electrolyte by previously discussed processes. The actual molar concentration of (SO₄)⁻² will be essentially unaltered but the portion of them that have hosted a third proton will be increased.

Additionally, the charged groups of molecules are somewhat stable and may diffuse intact; however, an outer shell of protons around the (SO₄)⁻² core extend to distances that include the approach proximity of other molecules during thermal collisions. When a neutral (2H⁺+SO₄⁻²) comes close to the protons surrounding the negative core (SO₄)⁻², during such a thermal collision there is some probability of one of the protons transferring to it. The energy budget for such collisions is intrinsically balanced at the ion/molecule level but, if there is a net electrostatic gradient, the extra proton will tend to move from the positive and toward the negative direction of the gradient. As the concentration of protons becomes high in a region the effects on the loosely bound protons therefore drives the distribution toward being uniform. There is a competition process between proton conduction (jumping from (SO₄)⁻² ion to (SO₄)⁻² ion) and diffusion of (3H⁺+SO₄⁻²)⁺ groups, by which the protons distribute themselves throughout the electrolyte and both processes are energetically powered by electrostatic forces and gradient fields.

Once first electrode 1701 has completed diffusing some additional protons into the electrolyte solution, ion transform platform 1704 is rotated and positioned under second electrode 1702 with gate electrode 1707 and gate insulator 1709 interposed between the electrolyte solution and second electrode 1702.

Gate electrode 1707 is insulated from the electrolyte solution and is positioned so as to impose an electrical gradient field across the path of travel of the inclusion and any ions within the inclusion, differing from the first electrode 1701. If the gate electrode 1707 is biased to an electrical potential, it will produce a gradient that will effect the (3H⁺+SO₄⁻²)⁺ ions to migrate toward the negative direction. From the previous discussion, it follows that this does not have to significantly concentrate (SO₄⁻²) into the region but the protons can migrate opportunistically to balance the gradient caused by the gate electrode 1707. When an electrical potential of the gate electrode 1707 is negative it will cause the second electrode 1702 electrical potential to be low and the mechanical power interchange 1710 will receive energy. When the gate electrode 1707 is positive it will consume energy to move the charged ion into the positive field. This will cause the open circuit potential of the second electrode 1702 to go more positive. The energy to power this higher potential will be supplied by the mechanical power interchange 1710.

The gate electrode 1707 is arranged so that the electrolyte solution is near the gate electrode 1707 as it is connected with the second electrode 1702. The electrode then neutralizes the protons using an oxidant such as atmospheric O₂ and a catalyst such as gold. Once it is neutral there is no more electrostatic force acing between the gate electrode and the electrolyte.

In the case of the second electrode 1702 being negative, the concentration of protons near the gate electrode 1707 is enriched. The electrolyte possesses a positive charge as a result of the surplus positive (3H⁺+SO₄⁻²)⁺ ions. These surplus positive ions will mainly migrate through the electrolyte by diffusion or by hopping from an occupied core to an unoccupied core. The actual molar concentration of (SO₄)⁻² will be essentially unaltered but the portion of them that have hosted a third proton will be increased in some areas. As the electrolyte in the openings is exposed to the second electrode 1702, protons will be converted to neutral water and an external current (supplying electrons to the second electrode). The inclusions will no longer be carrying a charge, so they will be easily transported to a different potential region.

Now consider the system's electrical flow. Hydrogen (H₂) enters at the first electrode 1701 and becomes dissociated by the catalyst but remains on the surface of the catalyst. As each proton encounters a host (2H⁺+SO₄⁻²) wherein it forms a (3H⁺+SO₄⁻²)⁺ group which is the most stable arrangement available to it. The catalyst accepts one electron from each hydrogen atom contributing it to the external circuit and the proton loses all affinity to the catalyst. These protons do not tend to associate in pairs as their positive charges comprise the dominant local influence. The ionized sulfate core (3H⁺+SO₄⁻²)⁺ is energetically weak but does serve to effectively contain the free proton. The modes of diffusion of the ion versus the ability of the proton to transfer to another (2H⁺+SO₄⁻²) have been discussed previously. The positively charged (3H⁺+SO₄⁻²)⁺ ions are drawn toward and tend to collect near the negative gate electrode and are carried past it by the motion of the table holding the inclusion (or flow of the stream).

The charged ions form a positive field and demand an extra electron for each proton. The electron can be provided by a carbon or noble electrode (or other conductive surface) and the electron in the electrolyte will neutralize the solution electrically ((3H⁺+SO₄⁻²)⁺+e−) (these are seldom able to chemically recombine due to the requirement for two protons and two electrons to congregate in one place to produce H₂ and gain an energy advantage). For the present example that is not the case as there is no noble electrode provided. Therefore, the charge will not neutralized and it is then forced by the movement of the inclusion to continue the path dictated by the platform 1704 in which case some energy from the force impelling the flow of the stream will be transferred into the electrical energy of the system.

The table 1704 or stream 1803, as shown in FIG. 18, is only a descriptive device, as it could be a structured membrane with proton-holding sites in isolated positions in an electrically non-conductive lattice that is moving by means of a mechanical drive. Alternatively, the stream could be non-conductive but contain colloidal inclusions that enclose proton-holding materials and the surface may be conductive or non-conductive.

The complementary half-cell is farther along the path of motion. The fluid may first proceed through a reduced aperture, non-conductive channel for a distance. This effectively increases the rate of flow and makes diffusion of the charged ions become a smaller factor as they are primarily swept along with the electrolyte. Farther downstream, the non-conductive channel may then enter the field of a second gate electrode that is set at a positive electrical potential. More energy is transferred to the system from the energy driving the flow of the stream as the positively charged (3H⁺+SO₄⁻²)⁺ ions are carried into the positive field. While they are within the influence of the positive field, the stream encounters an oxidizing electrode and the (3H⁺+SO₄⁻²)⁺ ions are relieved of their excess protons as the oxygen draws electrons from the electrode and accepts the protons to form water at a voltage significantly determined by the potentials of the gate electrodes and the properties of the load completing the electrical circuit.

It is expected that after learning these concepts, a skilled designer can derive and calculate the necessary relationships to predict that by providing other electrical potentials on the gate electrodes or by making changes in the electrolyte fluid flow rate it is possible to alter the rate at which protons are drawn into the stream and thereby influence the current flow and the efficiency. The voltage on the gate electrode located near the oxidizing electrode has an effect on the output potential. The force of the flow of the electrolyte will provide the energy to supply some of the output power. Further, it is expected that after learning these concepts, a skilled designer can derive and calculate the necessary relationships to predict that other choices of potentials of the two electrodes and the flow of the fluid can equally reduce or turn off output of the cell. The effects described above do not depend on the fluid being a liquid and in fact they work equally well if the fluid is a gas with proton acceptor sites and also if it is not a fluid but is a solid such as grains of sand mixed with silica gel particles containing proton-holding sites. There is an advantage if the fluid or lattice is an electrical non-conductor because that will prevent energy from being dissipated by electrical leakage.

Of course there are many choices of fuel such as methane, ethane, propane, butane, methanol, ethanol, propanol, glycerol, formic acid, and of oxidizers such as hydrogen peroxide, and metal-peroxides, permanganates, nitrates, atmospheric oxygen and others according to catalysts, temperatures and specifications to be met. Additionally after learning these concepts, a skilled designer can derive and calculate the necessary relationships to predict that the system is equally functional in the case where the oxidant is applied at the first electrode and acts as a source of electrons such as (O⁻²)⁻² or some specie that suits the electrolyte and the electrodes are oppositely arranged with a reductant at the second electrode. In that case the liquid may be alkaline or the colloids may be permeable to the species such as carbonates.

Based on the description above it can be seen that it is possible to adjust the potential of the gate electrode to influence the open-circuit external voltage of the cell and to adjust the speed of the table to influence the short-circuit external current. Of course there will be energy interchanged with the table the due to the integral of the electrostatic force and the distance over which it acts.

FIG. 18 is a simplified illustration of an electromechanical system 1800. Fuel cell system 1800 includes a first electrode 1801, an ion-hosting fluid which may be a colloid 1803, an ion or colloid particle 1804, a site wherein an ion may reside 1805, ion transfer fluid 1806, a gate electrode 1807, an independent electrical potential 1808, a gate insulator 1809, and mechanical input 1810. As can be seen FIG. 18 is similar to FIG. 17. However, while FIG. 17 relies on an electrically isolated inclusion 1703 and ion or site wherein an ion may be hosted 1706, FIG. 18, relies on a hosting material 1803 that contains ions (or colloids to hold charged ions) to move the charged ions from first electrode 1800 to the second electrode 1802.

As was true of the discussion of FIG. 17, even though the structures are different in some respects, they are identical in one respect, namely that it can be seen that it is possible to adjust the potential of the gate electrode to influence the open-circuit external voltage of the cell and to adjust the speed of the table to influence the short-circuit external current. Of course there will be energy interchanged with the table the due to the integral of the electrostatic force and the distance over which it acts. So these two structures are examples of a common operation at the level of the ion and the gate electrode.

It should be understood that a countering consideration is posed by the rule that no field can exist within a conductor. This rule is perfectly enforced within a superconductor, very well enforced within highly conductive metals, fairly well enforced in ionic solutions and poorly enforced within semiconductors. In this sense, de-ionized water at 70 degrees Fahrenheit and 20 MegOhm-Cm is a fair semiconductor. As H₂SO₄ is added to de-ionized water the resistance or the MegOhm-Cm drops rapidly and must be compensated by changes in the aspect ratio of the geometry during design. The water may be replaced by nonionic fluids with a colloidal suspension of silica gel spheres wetted with water and sulfuric acid or nano-particles such as Buckey balls filled with acid and water. The fluid can be a liquid, gas, plastic solid, plasma or grains of solid particles such as sand or resin. As each replacement is made the properties of the fluid become different. Again, the transport table can be a nanostructure such as a gear-shaped molecule with ion-binding cores such as SO₄⁻² ions on the teeth. A design engineer familiar with the art can understand the necessary structures. Although much of the theory discussed here is described in the macro level there are nano-scale equivalents in which the usefulness of the devices is quite high. In these cases there is sometimes a blending of the features of FIG. 17 and FIG. 18.

FIG. 19 is a simplified sectional illustration of an electrochemical cell 1900 that includes a first electrode 1901, a first reactant 1902, an ion hosting particle 1905, a site wherein an ion may reside 1906, a gel-membrane 1907, a structural material permeable to ions 1908, a structure able to retain ion-hosting particles 1909, an interface that limits mixing of a first reactant and a second reactant 1910 and a second electrode 1903.

As shown in FIG. 19, electrochemical cell 1900 is made with gel-membrane 1907 which allows ions to pass. The membrane is a structural substance such as silica gel that may be dense enough to have the property that fluids contained within it will tend to be very resistant to flow and will therefore limit the mixing of the first reactant 1902 with the second reactant 1903. The fluid contains molecules, such as sulfuric acid, that are strongly attracted to the silica threads and become ion-holding sites in the structure with the ability to pass ions (such as protons) along from one side of the membrane to the other side without moving significantly from their bound location. This membrane has some advantages because it can be formed from a sodium meta-silicate solution by adding an acid to remove the sodium and leaving behind the silica. This allows the silica gel to be formed at points under the control of photo-resist and the use of carbon dioxide to acidify the exposed region or similar methods using dyes and photon exposure.

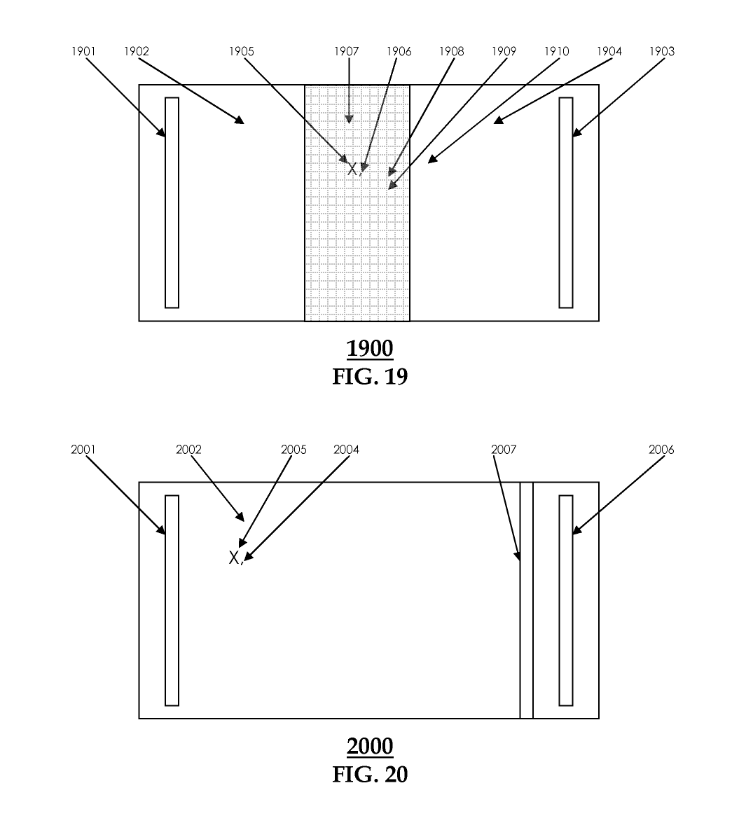

FIG. 20 is a simplified sectional illustration of an electrochemical half cell 2000, which includes a first electrode 2001, an ion-holding fluid 2002, an ion 2004, an ion hosting particle 2005, a gate electrode 2006, and a gate insulator 2007.

The first electrode 2001 creates ions from a fuel such as hydrogen (not shown) with its catalytic surface such as gold (not shown) by exchanging electrons through an external circuit (not shown) and the ions are hosted with local stability on a site on ion-hosting particle 2005 which may be a sulfuric acid core, that is suspended in a fluid 2002 such as water, and are quasi-stable because they cannot easily form more stable configurations. These ions carry a charge that repels other similar ions of like charge. The fluid 2002 thus formed has high-energy content particles that can be used in environments that allow them to release their energy into a proper environment. It is possible for the solution to be enriched by adding a gate electrode 2006 and a gate insulator 2007 interposed between the gate electrode and the half-cell to provide a field that can attract additional ions into the fluid to make it ion-rich, after which it may be taken to an environment where the high-energy particles can be used.

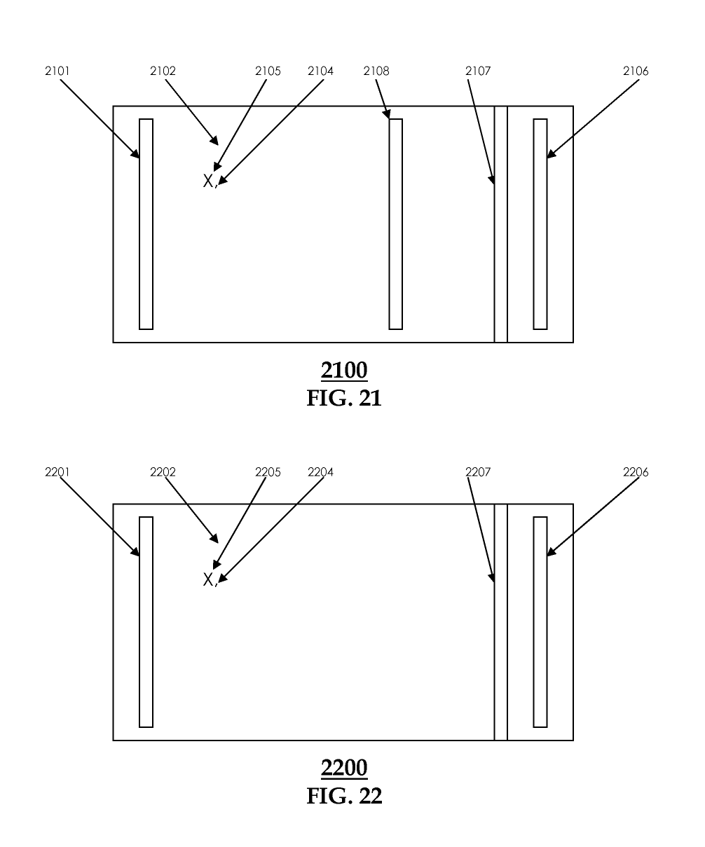

FIG. 21 is a simplified sectional illustration of an electrochemical cell 2100, which includes a first electrode 2101, an ion-holding fluid 2102, an ion-hosting particle 2105 hosting ion 2104, a gate electrode 2106, a second electrode 2108, and a gate insulator 2107.

The first electrode 2101 creates ions from a fuel such as hydrogen (not shown) with its catalytic surface such as gold (not shown) by exchanging electrons through an external circuit (not shown) and the ions are hosted with local stability on a site on ion-hosting particle 2105 which may be a sulfuric acid core, that is suspended in a fluid 2102 such as water, and are quasi-stable because they cannot easily form more stable configurations. These ions carry a charge that repels other similar ions of like charge.

Once formed, these ions tend to create a charged fluid which was counteracted in electrochemical cell 2000 by charging the gate electrode 2006. A second method will now be described. An inert electrode 2107 such as graphite may be placed in the fluid to provide electrons to the general solution from a ground connection (not shown) and neutralize the fluid. Because the protons trapped on the cores cannot readily react with the electrons unless they are supplied with oxygen and a catalyst, (except when fortuitous events such as cosmic rays interact, etc.) the solution 2102 can be made highly enriched. Gate electrode 2106 and gate insulator 2107 can be used when the solution is a non-conducting colloidal suspension, to create a more rapid reaction at the first electrode 2101.

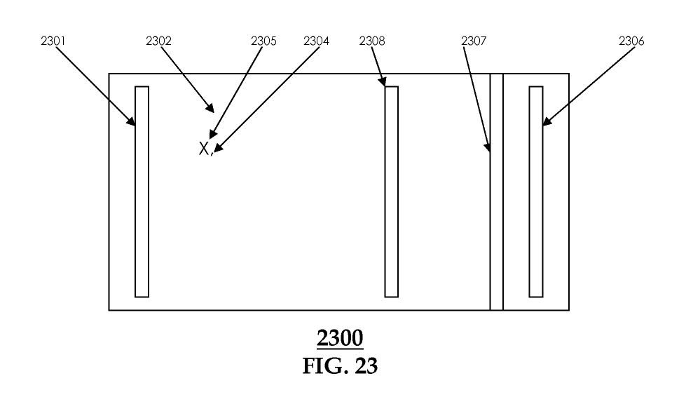

FIG. 22 is a simplified sectional illustration of a half cell 2200. Half cell 2200 includes a first electrode 2201, an ion-rich fluid 2202, an ion-hosting particle 2205, a gate electrode 2206, and a gate insulator 2207.

The first electrode 2201 can react with ions from the at least one ion-rich fluid 2202 to form molecules by having a catalytic surface such as platinum and being connected to an external circuit (not shown). The external circuit can accept electrons and oxygen can be supplied (not shown) to consume the protons provided by the high-energy molecules of the ion-rich fluid, forming an energy-rich fluid.

FIG. 23 is a simplified sectional illustration of an electrochemical cell 2300. Electrochemical cell 2300 includes a first electrode 2301, an ion-rich fluid 2302, an ion 2303, an ion-hosting particle 2305, a gate electrode 2306, a gate insulator 2307, and a second electrode 2308.

The electrical path can be completed by a gate electrode (in nano-scale applications) 2306 or by a graphite electrode 2308 in macro-scale applications. The gate electrode 2306 will attract electrons and allow the voltage to rise. This can be discharged by a complimentary function at the nano-scale rather than being an infinite integral. Its purpose is as a logic function and the action is controlled by enabling parameters. In the more generic macro-scale version the sea of electrons will seek to neutralize charge differences through the electrode 2308 as the protons are consumed.

In the previously described example of FIG. 17 a fuel cell with two gate electrodes at different potentials or voltages, that example is now extended by introducing electrically separated electrolyte containers or ion hosting inclusion 1703 as shown in FIG. 17. Each container 1703 receives a quantity of the flowing electrolyte that has passed the first gate electrode 1707. The electrical potential of the electrolyte will have a value that will be largely determined by the electrical potentials of the first electrode 1701 and the first gate electrode 1707.

Each container 1703 is consecutively charged with protons and then mechanically transported into a field of the gate electrode 1707 and its contents comprise the equivalent of an electrically isolated stream that flows past the oxygen electrode 1707. The purpose of the isolation is to prevent shunt currents from dissipating the energy within the cell. Because of the electrical charges and moving through gradient fields, work will be expended to move the containers 1703 with positively charged electrolyte from one potential to another. The cups 1703 may contain proton hosting fluids, ion-hosting fluids, gels or solids such as NAFION, isolated electrically and contained in electrically non-conductive structures (a moving structured membrane as shown in FIGS. 17, 18, 19, 20, 21, 22, and 23. Alternatively, a gate electrode may be around each of the cups or ion-hosting inclusions 1703 and move with them using commutation to apply the different gate voltages while the cup 1703 is in each electrode range or the gate electrode may be a fixed-position shield around the electrode locations wherein the cups enter and leave it.

As the electrically isolated stream or its segmented-container equivalents pass the oxygen electrode, its surplus protons find oxygen atoms that are dissociated on its catalytic surface. As each proton reaches an oxygen atom an electron is pulled from the conductive contact. When two protons have reached one oxygen atom and the electrons are in place, a molecule of water results. As the electrolyte cup passes the oxygen electrode it becomes depleted of surplus protons and is once more a cup of (2H⁺+SO₄⁻²) and water that can then be recycled to the initial stream by the system of electrically isolated containers.

It follows that this arrangement can be achieved without individual containers if the apparatus is designed to permit the fluids to be elevated and dripped in discrete drops to deliver the electrolyte from the first electrode to the second and similarly to return the fluids from the second stream back to the first stream where it can be recycled using the gap of air or other gas as the insulator.

### Example 4

### A Dismembered Fuel Cell System

When the electrolyte solution of the preceding example is stored in a non-conductive container and transported to be used with an oxygen electrode or the second electrode or electrolyte solution is not dedicated to the local fuel cell. The high concentration of (3H⁺+SO₄⁻²)⁺ ions may be thought of as a certain number of moles of chemically stored charge per volume waiting to be reacted in a half-cell. Admittedly if it is at a seriously high electrical potential due to excess charges there are additional considerations to be managed. To address that issue an electrode may be inserted into the electrolyte to set the charge as was referred to previously. The process is that the first gate electrode 1701, as shown in FIG. 17, will attract a strong concentration of (3H⁺+SO₄⁻²)⁺ and as the electrolyte solution leaves the influence of the negative field, a carbon electrode is contiguous with the flow and is maintained at a chosen potential. The electrically neutralized electrolyte in the container thus can power an oxygen-fed half fuel cell. Although this might not be sufficiently energy dense for some applications, it is a medium of storage with low investment because both H₂SO₄ and H₂O are fairly low-cost and abundantly available. In the oxidation reaction each (3H⁺+SO₄⁻²)⁺ ion yields one proton to a catalytically bound oxygen atom which then draws one electron from the conductive contact. One electron is then freed that was electro-statically bound to the electrolyte. The freed electron is then released to a carbon or noble element electrode. The free proton is available because although the third proton is lightly trapped, each proton is free part of the time.

It should be understood that in some cells the process of converting the fuel to the intermediate form such as (3H⁺+SO₄⁻²)⁺ is energy-consuming and the oxidative process is energy releasing. In those cases by having the energy consuming process occur in an environment where electrical, thermal or mechanical power from solar, wind, geothermal or other source is readily available, and wherein the energy releasing process to occur later in an entirely unrelated environment, it is possible to realize advantages such as higher electrode potentials, smaller, simpler and more reliable apparatus as well as the ability to efficiently operate at reduced power output ranges, thereby reducing total energy requirements while reducing the cooling load and total size and weight of the apparatus.

Another advantage of operating a half-cell with protons as the fuel is the freedom from having to transport or store highly pressurized hydrogen, the freedom from producing carbon dioxide as well as not poisoning the catalyst with carbon monoxide partial products.

The process of reducing the fuel to a stable form to be stored and used later is only an example. It is equally possible to convert the oxidizer to a stable intermediate especially for space applications where atmospheric oxygen is not readily available and streaming the oxidizer into the cell for power production.

### Example 5

### An Example of a Process Using Stored Protons with Ozone

A third process is to produce high-energy stable intermediates of fuel (3H⁺+SO₄⁻²)⁺ with free protons) and of oxidizers (O⁻, F⁻, Cl⁻, Br⁻, S⁻, S⁻² or O⁻² with free electrons) in separate environments and storing them as an efficient energy source at a later time. Examples of oxygen storage systems with the oxygen available at higher energy states include hydrogen peroxide, ozone, molten alkaline carbonate and O₂-conducting ceramic oxides. Each of these has environmental requirements and specific membrane requirements.

A double intermediate form is achieved by introducing one stream with a surplus of (3H⁺+SO₄⁻²)⁺ and a second stream with a surplus of (O⁻²)⁻² or equivalent and producing even higher terminal voltages wherein the two streams are allowed to react as the electrons are obtained from the charge excesses and deficits thereby permitting high energy outputs. This is a case where a central parallel laminar stream can be used as an induced dynamic conductive interface to be the effective membrane and the charges associated with neutralizing the carriers become the source of the current as the two components are allowed to react directly but using a non-conductive medium.

### Example 6

### An Example of a Solar Plant Scavenger

A solar power station that concentrates sunlight to a high intensity, concentrates the light onto a thermal receiver. Around the receiver is a high-pass optically coated quartz envelope to pass a wide band of light and also to permit control of the atmosphere around the heat transfer element. The internal atmosphere consists of purified oxygen that is concentrated from the atmosphere by a selective filter and the absolute pressure is maintained at an optimum for the system. The ultra-violet spectrum of the intense light converts a portion of the oxygen to (O₃) which is then removed by a centrifuge or by ionization with charge concentration and stored to provide energy during peak demand or low sunlight conditions. The spent oxygen (depleted ozone) is then returned to the light chamber to produce more ozone.

The ozone is presented to a weak catalyst such as carbon nanotubes to accept the high-energy oxygen and send the (O₂) to a secondary fuel cell or recycles it to produce more ozone. Because the catalyst is weak it will release the adsorbed O with a favorable electrode potential by pulling two electrons from the electrode to produce (O⁻²) as each of two protons are presented from (3H⁺+SO₄⁻²)⁺ ions as previously described. This now operates as a half-cell reaction, the opposite electrode can be carbon or platinum (whichever is cheaper) and only has to accept the electrons in the environment of (3H⁺+SO₄⁻²)⁺. Of course hydrogen peroxide and other peroxides, permanganates, etc. may also be used.

It is useful to provide an appropriate membrane because the carbon nanotubes can catalyze both halves of the process to produce heat which is often not desirable. A few molecular layer thickness of a mineral species such as alumna Al₂O₃, silicone polymers: poly-R-silane or geopolymers: (1.K:1.Al₂O₃:X.SiO₂:Y.H₂O) or hydrophilic silicone polymers to provide the desired membrane properties under specific conditions. The properties can also be achieved using an induced dynamic conducting interface where the fluid adjacent to the catalyst is a low molecular weight hydrophilic silicone polymer (or monomer) (to permit the removal of waste water). This list is not exhaustive and is limited by reason of the many possible catalysts, ion transport choices, etc.

Additionally, in the forgoing discussion it has been discussed that protons from a fuel half-cell or oxidant ions from an oxidation half-cell must be conducted to reach the other half-cell. In the case of protons passing from a fuel half-cell, the conductive material will have acid properties because that is related to an excess of protons and therefore will not have ions that will react to capture the ions. In the case of oxidizing ions passing from an oxidant half-cell the conductive material will have alkaline properties because that is related to an excess of oxidizing ions and therefore will not have ions that will react to capture the ions.

In any one fuel cell charged ions will typically be emitted from only one of the electrodes. The ion-conductive medium or electrolyte solution must provide a non-reactive environment that does not quench the carriers. Furthermore the ion-conductive medium or electrolyte solution should provide host sites where the carriers are locally stable and also possess a supply of ions or dipolar molecules that can distribute the charge of each carrier. Without the last two properties it would be difficult to launch the carriers from the catalyst of the electrode. If that were not important we could use a vacuum as the carrier but experience has taught that this requires a heated emitter, photo-excited emission or other facilitator.

If the protons are moving through an acid such as water plus H₂SO₄ the protons will transfer from one host to the next during thermal collisions. Furthermore the group of molecules around a captive proton will tend to be drawn as a whole in the negative direction of a gradient. The former process will predominate at high temperatures and the converse at low temperatures.

The principal requirement for a cell to operate is that the ions must be basically stable in the environment provided to conduct them. That extends to filling containers with the conductive medium and an excess of charged carriers in stable states but with the net charge able to be chosen without affecting the ion content. In some cases the site where the charge will reside is quasi-stable and will decay over time and in other cases they may be stored as a standard chemical. In the case of H₂SO₄ with an extra proton, the proton could accept an electron from the environment to make a hydrogen atom but this does not provide the energy to release it from the sulfate core, whereas if it were able to do so in a pair such that it formed an H₂ molecule the energy would be sufficient. In a system of (3H⁺+SO₄⁻²)⁺ there will be occasions where two protons will come close to each other and can accept an pair of electrons in spite of the electrostatic repulsion. That makes the lifetime of the solution finite at high temperatures.

In either the acid or the alkaline case, free electrons will aggregate or disperse as necessary to maintain the electrical potential that is dictated by other environmental circumstances such as a gate electrode. This means that the effectiveness of a poorly designed gate system is very small. The electrical conductivity of the typical acid solution will not permit the field to enforce strong effects other than with very extreme aspect ratios or similar circumstances. Therefore it is favorable to have a non-conductive system that can accept protons, electrons or negative ions. This requirement is not important in common electrochemical cells without the membrane gate structure.

One example system is a solution of nano-size particles with acid cores and porous shells such as tiny spheres of silica gel with molecules of H₂SO₄ and H₂O adhered to the SiO₂ fibers of the silica gel (which has a high affinity for H₂SO₄ and H₂O) and will effectively trap acid molecules and a number of water molecules around each that will not be otherwise mobile. These are then suspended in such things as very pure water or a non-ionic liquid and will behave as proton storage units. The outside of each porous core may be passivated with a monolayer of carbon or silane to form a conductive or non-conductive surface.

A smaller structure with high performance is carbon Buckey balls with H₂SO₄ molecules and water formed inside. Because Buckey balls (or nanotubes or graphene) are permeable to protons but not to larger molecules they can be suspended in de-ionized water without contaminating it. The process of producing these comprises some trial and error. High energy streams of sulfur, hydrogen and oxygen are sequentially beamed on the balls and the balls are given the opportunity to accept protons and become charged. The charged balls are easily sequestered and the others are reprocessed. A more reliable system is made by using carbon nanotubes which can be filled with sulfuric acid and water and then sealed at the ends or suspended in a non-ionic fluid. These can be processed in alkaline media to form an outer shell of silica or various radicals while still remaining porous to protons.

### Example 7

### Mechanical and Electrical Energy Interchange

Again visiting the device of FIG. 17 that can support moving captive carriers in a planned path is a structured membrane wherein isolated compartments of wetted acidic silica gel are aligned on the surface of a non-conductor such as silicon dioxide that can move from the region of the anode half-cell where each compartment of gel may be charged with protons to the region of the cathode half-cell with gate electrodes independently controlling the local potentials. If the gate electrode is negatively biased it will attract many protons into the gel. This structure will now be examined in a different system.

In the case where charged compartments are moved through a gradient from one local potential to another, there is some amount of mechanical energy associated with moving the charge to the second potential. This may contribute to the output power of the cell thereby making it act as a generator. Conversely if the path is in the negative direction, the system acts as a motor. Because it derives from electrostatic forces the power density of this type of mechanism is most effective in smaller-scale systems. Now suppose that the compartments are mechanically connected to a mechanical input/output such that a shaft will move compartments to a proton-source electrode for a duration that will permit it to reach an amount of charge that is associated with the bias voltage of the gate electrode compared to the potential of the proton source (delta bias 1). For a compartment proton capacity and capacitance of the gate electrode to the gel, the charge per compartment will be proportional to the delta bias 1. Next, the compartment is moved to a new gate electrode whose electrical potential is higher and is also exposed to an oxidizing electrode whose voltage is determined by its load properties. The protons in the gel are free to react with the oxidizing electrode and do so to the total amount of charge that is associated with: the bias voltage of the gate electrode compared to the potential of the proton source (delta bias 2). For this example the compartments are so arranged that, at all times at least one compartment is in contact with each electrode. It is therefore apparent that the open-circuit output voltage of the cell will be the voltage that which would be true for the unbiased cell plus the voltage difference between the two gate electrodes and the closed circuit current of the cell would vary with the number of cells passing the electrodes per unit time and the magnitudes of delta bias 1 and delta bias 2.

Similar behavior is of course to be found where the compartments are micro or nano-sized particles suspended in a carrier fluid which may have an energy input from a pump or the pressure from a tank as is otherwise described herein. Conversely a fluid may be impelled by having charged particles contained and a gradient that creates a directed force. The fact that in some cases there will be mechanical energy available from external sources (such as a tank of hydrogen gas) that also provide chemical energy this can be captured for use as an efficiency enhancement. In other cases a mechanical engine may be powered by one energy source and its work output can be used to drive an electrochemical cell as a generator.

The fact that each electrode pair in some types of electrochemical cells may be expensive or short-lived lends an advantage to forming one cell with a high current capability that can draw energy from a mechanical source while being able to be controlled by bias voltages thereby reducing the number of required cells. In other cases a system of cells may produce power by purely electrochemical means without mechanical input but be able to be biased to different open-circuit or short-circuit voltages without undue loss of efficiency.

The set of useful applications for the membrane gate is large. One aspect of the invention adds a means to provide mechanical input power to an electrochemical cell thereby converting mechanical power to electrical. Another aspect adds a mechanical input to an electrochemical cell and converts the power to a chemical form. Another aspect adds control of the output of an electrochemical cell by setting gate bias voltages. Another aspect controls the output of an electrochemical cell by control of input power from a shaft. Another aspect produces an output force on a shaft by use of electrostatic charges and bias voltages. Another aspect controls the output of an electrochemical cell by inputting power by impelling a stream of fluid. Another aspect impels a fluid by electrostatic charge and bias voltages. Another aspect is to produce intermediate ions in a stable form that can be used in a plurality of corresponding complementary half-cells at different times. Another aspect of the invention is to produce intermediate ions and transport them to remote or mobile locations as a stored energy source in lieu of fuel. These leads to at least nine applications that, after learning these concepts, a skilled designer can derive and calculate the necessary relationships to so enumerate. The applications are therefore set forth as fully obvious extensions of the examples given.

While various embodiments of the gated fuel cell have been described as being able to be built on a silicon wafer in a foundry it will be apparent to those of ordinary skill in the art that by omission of the gate the present invention may equally be used to produce un-gated fuel cells, with or without a membrane, on a silicon wafer in a foundry. It is also apparent that the processes to make the fuel cells function do not depend on silicon foundry processes and can be equally achieved with a variety of materials by striking, extruding, rolling, vacu-forming and many other industrial processes. The small size in two dimensions easily permits densely placing the cells on one or two sides of thin material and stacking many layers to produce high power density fuel cell structures of various voltages, currents and numbers of outputs.

While various embodiments of the invention have been described, it will be apparent to those of ordinary skill in the art that other embodiments and implementations are possible within the scope of the invention. Accordingly, the invention is not to be restricted except in light of the attached claims and their equivalents.

What is claimed is:

1.-9. (canceled)

10. An electromechanochemical cell, comprising:
a first half-cell comprising:
at least one first electrode able to create ions, and a first reactant;
a second half-cell comprising:
at least one second electrode able to reduce ions, and a second reactant; and
at least one site wherein at least one ion may reside with local stability;
at least one ion resident in the at least one site; and
at least one non-conductive material between the at least one first and the at least one second electrode;
at least one mechanical input port; whereby: the at least one site is moved from the at least one first electrode to the at least one second electrode, thereby completing the current path of the cell.

11. The electromechanochemical cell of claim 10, wherein mechanical energy is interchanged with the at least one ion through the mechanical input port by a rate of movement of the at least one site, with respect to the at least one second electrode thereby influencing the current of the cell.

12. The electromechanochemical cell of claim 10, further comprising:
at least one inclusion containing:
the at least one site wherein at least one ion may reside with local stability,
the at least one ion resident in the at least one site; and
at least one non-conductive lattice able to contain an inclusion wherein:
the at least one inclusion is contained in the lattice;
the at least one mechanical input port; whereby the at least one ion is moved from the at least one first electrode to the at least one second electrode, thereby completing the current path of the cell.

13. The electromechanochemical cell of claim 10, further comprising: at least one colloid containing:
the at least one site wherein the at least one ion may reside with local stability,
the at least one ion resident in the at least one site; and
at least one non-conductive fluid able to suspend a colloid; wherein:
the at least one colloid is suspended in the fluid,
the at least one mechanical input port; whereby the at least one ion is moved from the at least one first electrode to the at least one second electrode, thereby completing the current path of the cell.

14. An electromechanochemical cell, comprising:
a first half-cell comprising:
at least one first electrode able to create ions, and a first reactant;
a second half-cell comprising:
at least one second electrode able to reduce ions, and a second reactant; and
at least one site wherein at least one ion may reside with local stability;
at least one ion resident in the at least one site; and
at least one conductive contact separately electrically connected to each of:
the at least one first electrode, and the at least one second electrode; and
at least one gate insulator; and
at least one gate electrode; wherein the at least one gate insulator is interposed between the at least one gate electrode and the at least one conductive contact, and
at least one mechanical input port; whereby a relative position of the at least one ion to the at least one gate electrode is moved, and
an electrical potential of the at least one ion; influenced by:
a relative position of the at least one ion to the at least one gate electrode,
an independent electrical potential of the at least one gate electrode; whereby mechanical energy is interchanged with the electrical potential of the at least one ion influencing the output voltage of the cell.

15. The electromechanochemical cell of claim 14, further comprising:
at least one inclusion containing:
the at least one site wherein at least one ion may reside with local stability,
the at least one ion resident in the site; and
at least one lattice able to contain an inclusion; wherein:
the at least one inclusion is contained in the lattice;
the at least one mechanical input port wherein energy is interchanged with the at least one ion by changing:
the relative position of the at least one inclusion to the at least one gate electrode,
the independent electrical potential of the gate electrode; thereby influencing the output voltage of the cell.

16. The electromechanochemical cell of claim 14, further comprising:
at least one colloid containing:
the at least one site wherein the at least one ion may reside with local stability,
the at least one ion resident in the site; and
at least one fluid able to suspend a colloid wherein:
the at least one colloid is suspended in the fluid,
the at least one mechanical input port wherein energy is interchanged with the at least one ion by:
changing the relative position of the at least one colloid to the at least one gate electrode,
the independent electrical potential of the at least one gate electrode; thereby influencing the output voltage of the cell.

17. An electrochemical half-cell comprising:
at least one electrode; able to reduce at least one ion, and
at least one site; wherein at least one ion may reside with local stability, and
at least one ion-rich ion-hosting fluid comprising:
at least one fluid,
the at least one site within the at least one fluid,
at least one ion residing in the at least one site with local stability; and
wherein the at least one first electrode can reduce the at least one ion from the at least one ion-rich ion-hosting fluid to form at least one molecule.

18. The electrochemical half-cell of claim 17 further comprising at least one second electrode arranged to complete an external electrical circuit by reduction of ions to form at least one molecule with electrons at the at least one second electrode.

19. The electrochemical half-cell of claim 18 wherein the cell produces an external current and voltage by reduction and formation of the at least one molecule in the half-cell from the at least one ion.
